(19) United States
(12) Patent Application Publication
(10) Pub. No.: US 2007/0271128 A1
(43) Pub. Date: Nov. 22, 2007

(54) Web based management information system

(76) Inventor: Raynard Terrence Bolling, Baltimore, MD (US)

Correspondence Address: Raynard Terrence Bolling, Suite B304, 1101 E. 33rd St., Baltimore, MD, 21218, US

(21) Appl. No.: 11/437,099

(22) Filed: May 19, 2006

(51) Int. Cl. G05B 19/418

(52) U.S. Cl. 705/8

(57) ABSTRACT

The present invention provides a web based management information system that may allow access to its plurality of features from any Internet enabled browser. Users of the web based management information system may access an online web-server via a URL and then login into the system using a username and password. Users may work on the same or different programs/projects and may communicate with other system users. The system facilitates user tasks such as project analysis, project management, report generation, time management and program tracking.

### FIELD OF THE INVENTION

The present invention relates to multiple-user, Internet accessible, computer software stored on a web-server. More specifically, the present invention relates to the field of software-aided project management.

### BACKGROUND OF THE INVENTION

Management information software products are widely utilized in today's corporate and government business environments for various program and project related purposes. Such software lack scalability, adaptability and data integration features that are necessary features for corporations and government agencies. Additionally, such software, are often stored locally on a personal computer or network accessible drive and is, therefore, not accessible by persons who reside at remote locations. Persons at such remote locations cannot access critical components of the software like the scheduler, task assignments, personnel information, milestones, budget data, and reports. Such persons must resort to email or telephone communication with another whom may have access to the software. In addition to the overhead and delay involved in having to contact local users to access these critical components, remote users risk receiving outdated and/or incorrect information because they cannot easily access the software. The problems associated with the local software's accessibility bottleneck coupled with the lack of scalability, adaptability and data integration features create the overwhelming need for a remotely accessible, scalable and adaptable web based management information system. The software would allow for all persons associated with a program/project to be able to access the same information from any Internet enabled computer via a web-browser. Each person would have a unique user identification and password, and would not be able to modify the same data as another user concurrently. Further, each person would have a different level of access that would allow for increased or decreased access to the software's features.

### SUMMARY OF THE INVENTION

The present invention relates to multiple-user, Internet accessible, computer software stored on a web-server. More specifically, the present invention relates to the field of software-aided project management. In one embodiment, the present invention provides an online project management system comprising a project analysis feature, a project management feature, a report generating feature, a time management feature, and a program dashboard feature.

In another embodiment, the project analysis feature may comprise a confidence level component, a matrix analysis component, a breakeven analysis component, and a payback analysis component. The confidence level component may comprise a project type component and a comparison component. The project type component may comprise a type and a cost. The comparison component may comprise a number of units to be entered, a mean value displayed, an absolute variance calculated, a standard deviation calculated, a probability score, a confidence interval, and a confidence level score.

In yet another embodiment, the matrix analysis component may comprise a submit option, a create analysis option, a review analysis option, and a delete analysis option. The create analysis option may comprise an evaluation criteria field, an analysis title field, proposed solutions fields, a create option, a save option, evaluation criteria, and an evaluation score. The web based management information system may further comprise a new matrix for analyzing management benefits criteria, project analysis criteria, project management criteria, reports criteria, system administration criteria, and time management criteria. In another embodiment, the review analysis option may comprise a submit option, a review field, an update option, evaluation criteria, and an evaluation score. In an alternative embodiment, the delete analysis option may comprise a submit option and a delete field.

In another specific embodiment, the breakeven analysis component may comprise a submit option, a create analysis option, a review analysis option, and a delete analysis option. The create analysis option may comprise a create option, a title field, a years field, a months field, a percentage or whole dollars option, a current system field, a current cost field, a current yearly growth field, a current monthly growth field, a proposal system field, a proposal cost field, a proposal yearly growth field, a proposal monthly growth field, and a save option. In another embodiment, the review analysis option may comprise a submit option, a review option, an update option, a selection field, a detailed breakeven analysis, and a breakeven score. The delete analysis option may comprise a submit option and a delete field.

In a specific embodiment, the payback analysis component may comprise a submit option, a create analysis option, a review analysis option, and a delete analysis option. The create analysis option may comprise a create option, a title field, a years field, a months field, a percentage or whole dollars field, a current system field, a current cost field, a current yearly growth field, a current monthly growth field, a proposal system field, a proposal cost field, a proposal yearly growth field, a proposal monthly growth field, and a save option. The review analysis option may comprise a submit option, a review option, an update option, a selection field, a detailed payback analysis, and a payback time. In another embodiment, the delete analysis option may comprise a submit option and a delete field.

In one embodiment, the project management feature may comprise a project definition component, a cost determination component, a staffing component, a close component, an archive component, a delete component, a project progress component, and a project template component. In another embodiment, the project definition component may comprise a load project component, a define project component, a task planner component, a direct labor component, a direct material component, a direct cost component, and a submit component. In yet another embodiment, the load project component may comprise a submit option, a start date, and a selection field. In one embodiment, the define project component may comprise a save option, a project title, a charge number, a start date, an end date, a program area, a program ID, a project category, a set baseline option, an approval field, a cost engine field, a schedule type field, and a units field.

In the web based management information system of the present invention, the task planner component may comprise a save option, an add option, a delete option, a task definition, a start date, an end date, and a length of time. In one embodiment, the direct labor component may comprise a save option, a milestone field, a project task, a start indicator, an end indicator, a slack field, a position field, a task total, a staff field, check availability option, a start date, and an end date. In another embodiment, the direct material component may comprise a save option, an item, a cost, and a remark. The direct cost component may comprise a save option, an item, a cost, and a remark. The cost determination component may comprise an active cost engine component and a cost proposal component. The staffing component may comprise a notification component. The archive component may comprise a project list and an archive option. The delete component may comprise a submit option and a selection field. In one embodiment, the project progress component may comprise a submit option, a selection field, and a progress report. The project template component may comprise a submit option, a selection field, and a template field.

The report generating feature of the present invention may comprise an actual detail component, an actual summary component, a plan summary component, an analysis component for comparing a plan summary against an actual summary, an analysis component for comparing a plan summary against a baseline summary, and an analysis component for comparing a plan summary, a baseline summary, and an actual summary. The actual detail component may comprise a retrieval component and an actual detail report. The retrieval component may comprise categories, a start date, an end date, and a project field. The actual summary component may comprise a retrieval component and an actual graphical and non-graphical summary report. The retrieval component may comprise categories, a start date, an end date, a project field, a text option, a graph option, a graph display type option, and chart properties. The plan summary component may comprise a retrieval component and an actual graphical and non-graphical summary report. The retrieval component may comprise a project field, a start date, an end date, a text option, a graph option, a graph display type option, and chart properties.

The analysis component for comparing plan summary against actual summary may comprise a retrieval component and an actual graphical and non-graphical summary report. The retrieval component may comprise a project field, a text option, a graph option, a start date, an end date, a graph display type option, and chart properties. The analysis component for comparing plan summary against baseline summary may comprise a retrieval component and an actual graphical and non-graphical summary report. The retrieval component may comprise a project field, a text option, a graph option, a start date, an end date, a graph display type option, and chart properties. The analysis component for comparing plan summary, baseline summary, and actual summary may comprise a retrieval component and an actual graphical and non-graphical summary report. The retrieval component may comprise a project field, a text option, a graph option, a start date, an end date, a graph display type option, and chart properties.

In one embodiment, the time management feature of the present invention may comprise a time entry component, a correct time entry component, a progress report component, an approve time component, and a create time component. The time entry component may comprise a save option, a time entry header, an alert, a task, a balance, a start date, an end date, days of week fields, a total time field, a progress report field, and a signature field. The correct time entry component may comprise time entry choices, a save option, a time entry header, a task, a balance, a start date, an end date, days of week fields, a notification field, and a signature field. The progress report component may comprise an itemized details of progress. The approve time component may comprise time entry choices, a submit option, a staff field, a save option, a time entry header, a task, a balance, a start date, an end date, days of week fields, a comments field, and a signature field. The create time component may comprise a submit option and a week field. The program dashboard feature may comprise a summary view component and a detailed view component. The summary view component and detailed view component each may comprise a project status, a task status, a progress report, and a project timeline report.

### BRIEF DESCRIPTION OF THE FIGURES

FIG. 1 shows the web based management information system's collapsed menu.

FIG. 2 shows the expanded menu of the project analysis feature.

FIG. 3 shows the expanded menu of the project management feature.

FIG. 4 shows the expanded menu of the report generating feature.

FIG. 5 shows the expanded menu of the time management feature.

FIG. 6 illustrates one embodiment of the project analysis feature's confidence level component.

FIG. 7 illustrates one embodiment of the project analysis feature's matrix analysis component.

FIG. 8 illustrates the create analysis option of the project analysis feature's matrix analysis component.

FIG. 9 illustrates one embodiment of the project analysis feature's matrix analysis component.

FIG. 10 illustrates the review analysis option of the project analysis feature's matrix analysis component.

FIG. 11 illustrates one embodiment of the project analysis feature's matrix analysis component.

FIG. 12 illustrates the delete analysis option of the project analysis feature's matrix analysis component.

FIG. 13 illustrates one embodiment of the project analysis feature's breakeven analysis component.

FIG. 14 illustrates the create analysis option of the project analysis feature's breakeven analysis component.

FIG. 15 illustrates the review/update analysis option of the project analysis feature's breakeven analysis component.

FIG. 16 illustrates one embodiment of the project analysis feature's breakeven analysis component.

FIG. 17 illustrates one embodiment of the update option of the project analysis feature's breakeven analysis component.

FIG. 18 illustrates the delete analysis option of the project analysis feature's breakeven analysis component.

FIG. 19 illustrates one embodiment of the project analysis feature's payback analysis component.

FIG. 20 illustrates the create analysis option of the project analysis feature's payback analysis component.

FIG. 21 illustrates the review/update analysis option of the project analysis feature's payback analysis component.

FIG. 22 illustrates one embodiment of the project analysis feature's payback analysis component.

FIG. 23 illustrates one embodiment of the update option of the project analysis feature's payback analysis component.

FIG. 24 illustrates the delete analysis option of the project analysis feature's payback analysis component.

FIG. 25 shows a load project embodiment of the project management feature's project definition component.

FIG. 26 shows a define project embodiment of the project management feature's project definition component.

FIG. 27 shows a task planner embodiment of the project management feature's project definition component.

FIG. 28 shows a direct labor embodiment of the project management feature's project definition component.

FIG. 29 shows a direct material embodiment of the project management feature's project definition component.

FIG. 30 shows a direct cost embodiment of the project management feature's project definition component.

FIG. 31 illustrates one embodiment of the project management feature's cost determination component.

FIG. 32 illustrates one embodiment of the project management feature's cost determination component.

FIG. 33 illustrates one embodiment of the project management feature's staffing component.

FIG. 34 illustrates one embodiment of the project management feature's archive component.

FIG. 35 illustrates one embodiment of the project management feature's delete component.

FIG. 36 illustrates one embodiment of the project management feature's project progress component.

FIG. 37 illustrates one embodiment of the project management feature's project template component.

FIG. 38 depicts one embodiment of the report generating feature's actual detail component.

FIG. 39 depicts one embodiment of the report generating feature's actual summary component.

FIG. 40 depicts one embodiment of the report generating feature's plan summary component.

FIG. 41 depicts one embodiment of the report generating feature's analysis component for comparing a plan summary against an actual summary.

FIG. 42 depicts one embodiment of the report generating feature's analysis component for comparing a plan summary against a baseline summary.

FIG. 43 depicts one embodiment of the report generating feature's analysis component for comparing a plan summary, a baseline summary, and an actual summary.

FIG. 44 shows one embodiment of the time generating feature's time entry component.

FIG. 45 shows one embodiment of the time generating feature's correct time entry component.

FIG. 46 shows one embodiment of the time generating feature's correct time entry component.

FIG. 47 shows one embodiment of the time generating feature's progress report component.

FIG. 48 shows one embodiment of the time generating feature's approve time component.

FIG. 49 shows one embodiment of the time generating feature's approve time component.

FIG. 50 shows one embodiment of the time generating feature's create time component.

FIG. 51 illustrates one embodiment of the administrative user application.

FIG. 52 illustrates that an administrative user may configure the system by defining certain parameters.

FIG. 53 shows that an administrative user may create a program area.

FIG. 54 shows that an administrative user may alter an existing program area.

FIG. 55 shows that an administrative user may delete an existing program area.

FIG. 56 demonstrates that an administrative user may create a program category.

FIG. 57 demonstrates that an administrative user may alter an existing program category.

FIG. 58 demonstrates that an administrative user may delete an existing program category.

FIG. 59 shows that an administrative user may create an analysis matrix.

FIG. 60 shows that an administrative user may alter an existing analysis matrix.

FIG. 61 shows that an administrative user may delete an existing analysis matrix.

FIG. 62 illustrates that an administrative user may create a cost engine.

FIG. 63 illustrates that an administrative user may alter an existing cost engine.

FIG. 64 illustrates that an administrative user may delete an existing cost engine.

FIG. 65 demonstrates that an administrative user may create a user.

FIG. 66 demonstrates that an administrative user may alter an existing user.

FIG. 67 demonstrates that an administrative user may delete an existing user.

FIG. 68 shows that an administrative user may switch a project from one user to another user.

FIG. 69 shows that an administrative user may alter an existing project.

FIG. 70 shows that an administrative user may delete an existing project.

FIG. 71 depicts one embodiment of the level of confidence results.

FIG. 72 depicts one embodiment of the program dashboard program area results.

FIG. 73 depicts one embodiment of the program dashboard project results.

### DETAILED DESCRIPTION OF THE INVENTION

It is understood that the present invention is not limited to the particular methods and components, etc, described herein, as these may vary. It is also to be understood that the terminology used herein may be used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a component, option, field, report or criterion” is a reference to one or more “components, options, fields, reports or criteria” and includes equivalents thereof known to those skilled in the art and so forth.

Unless defined otherwise, all technical and scientific terms used herein have the same meanings as commonly understood by one of ordinary skill in the art to which this invention belongs. Specific methods, devices, and materials are described, although any methods and materials similar or equivalent to those described herein can be used in the practice or testing of the present invention.

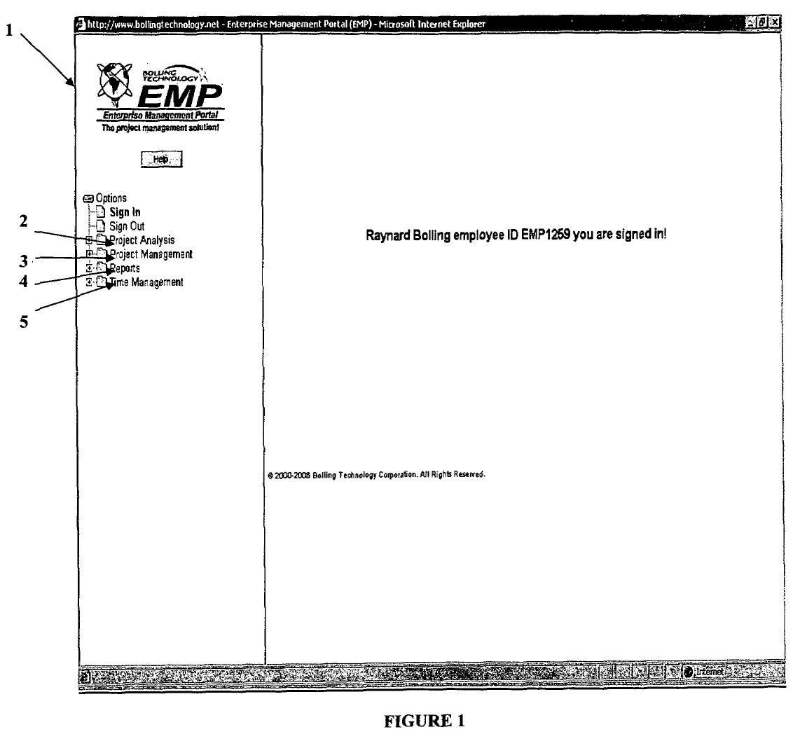

Referring to FIG. 1, the present invention comprises a web based management information system 1 that may include, but is not limited to, a project analysis feature 2, a project management feature 3, a report generating feature 4, and a time management feature 5. In one embodiment, the present invention may further comprise a program dashboard feature.

The system 1 may allow users to connect to its plurality of features using methods well known in the art including, for example, connecting from any Internet enabled web browser via a uniform resource locator (URL), username, and password. In certain embodiments, different users may have different levels of access or privileges. In other embodiments, a backend database may be routinely queried by the system 1 to retrieve or store information.

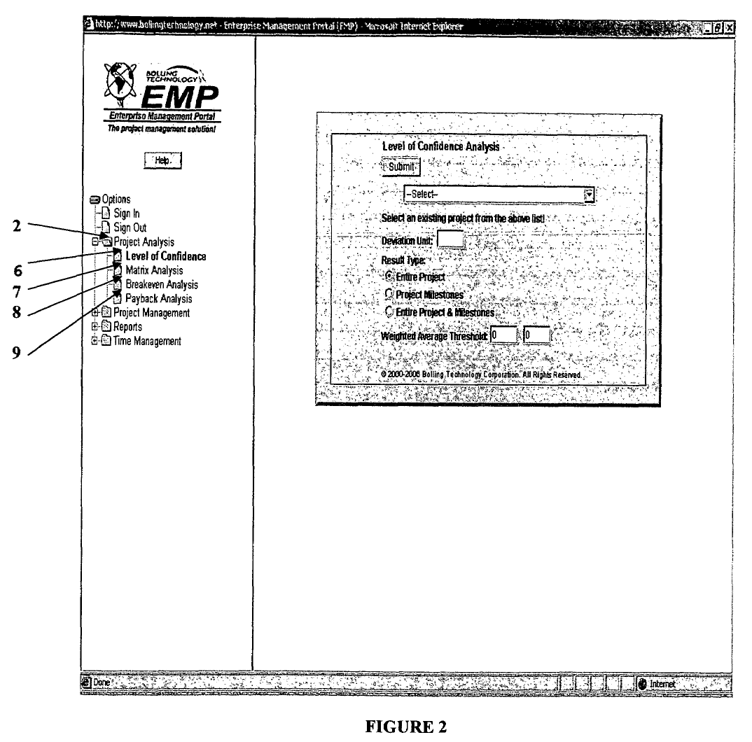

As shown in FIG. 2, the project analysis feature 2 of the system 1 may comprise, but is not limited to, a confidence level component 6, a matrix analysis component 7, a breakeven analysis component 8, and a payback analysis component 9.

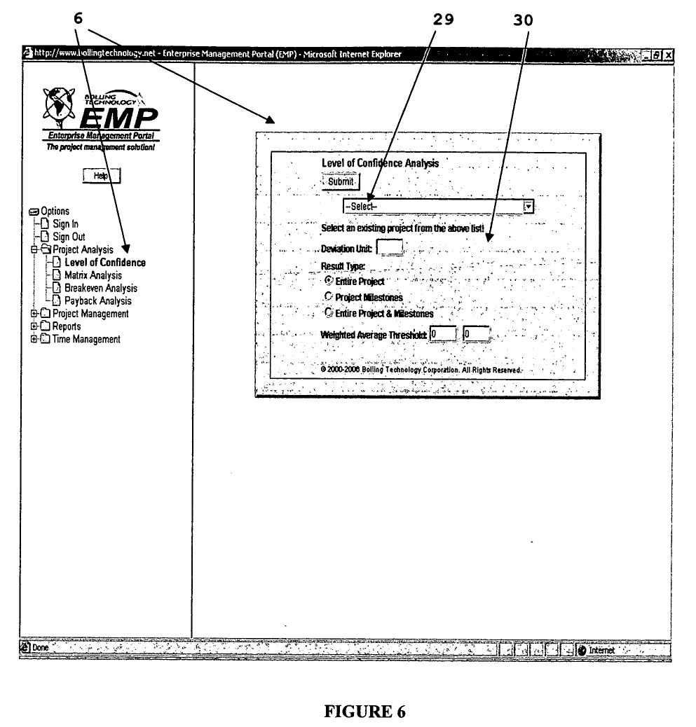

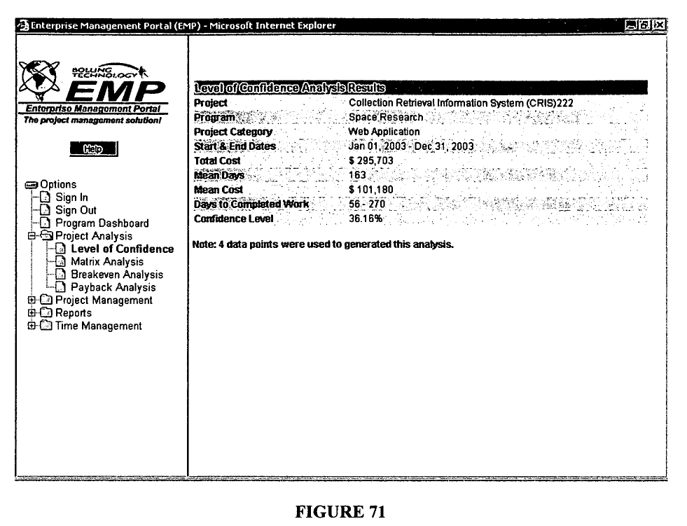

In the embodiment illustrated in FIG. 6, the confidence level component 6 of system 1 may comprise, but is not limited to, a project type component 29 and a comparison component 30. The project type component 29 may allow users of the system 1 to choose the historical project type basis upon which the respective confidence level of the user's new project will be calculated. The comparison component 30 may then receive a unit value away from mean, which is entered by the user. The comparison component 30 may then generate particular outputs including, but not limited to, a mean value, absolute variance, standard deviation, probability score, confidence interval, and confidence level score. These values may be used to determine the feasibility of a new project based on an underlying algorithm used to generate the values. In another embodiment of the present invention, the confidence level may be generated using the entire project and, for example, the statistical parameters of mean, absolute variance, standard deviation, and probability. In yet another embodiment, the confidence level may be generated using the project's milestones and/or phases. Persons using the project's milestones and/or phases will be able to evaluate the difficulty of such milestones and/or phases based on the resultant confidence level. In another embodiment, users may generate the confidence level based on the entire project and the project's milestones and/or phases simultaneously. FIG. 71 shows the results from a level of confidence analysis.

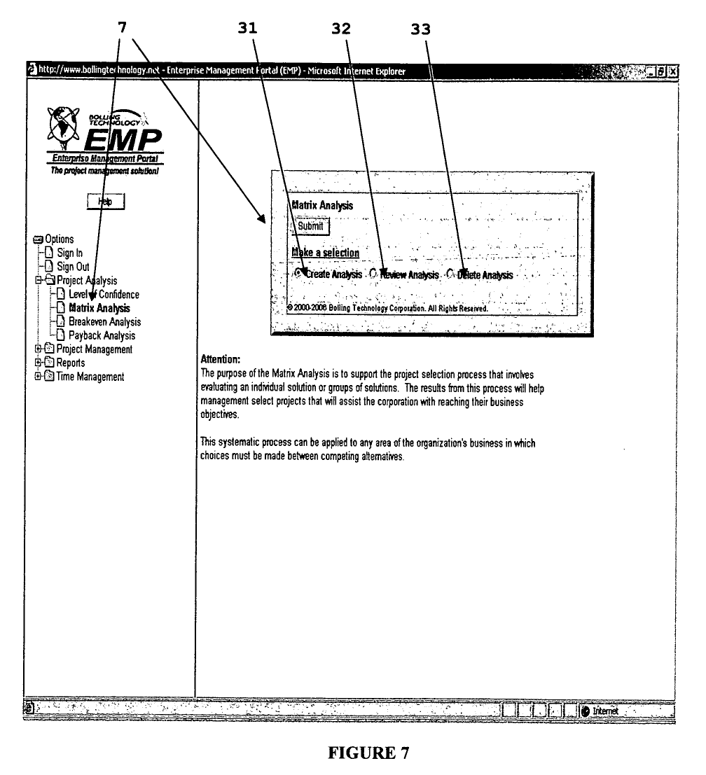

With reference to FIG. 7, the matrix analysis component 7 of the system 1 may be used to support a user's project selection process and evaluation of a single solution or set of solutions. The results of this process may help the user to select the appropriate projects for furthering the user's objectives. This systematic process can be applied to any area of an organization's business where choices are made among competing alternatives.

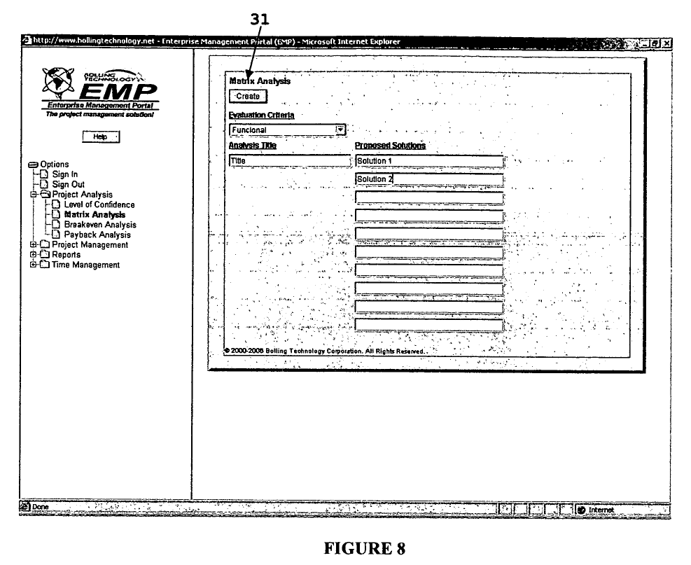

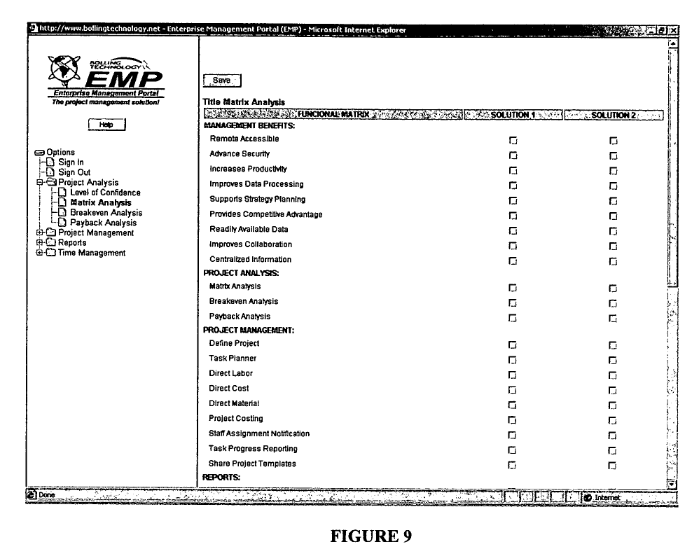

As shown in FIGS. 7-9, the matrix analysis component 7 of the system 1 may comprise a create analysis option 31, review analysis option 32, and delete analysis option 33. In certain embodiments, the create analysis option 31 may allow users of the system 1 to evaluate the best course of action for a specific project task based on a set of proposed economic or non-economic solutions that may be divided into specific evaluation criteria like, for example, functional or non-functional criteria. Users may create a plurality of matrix analyses, each of which may be distinguished by a unique title. Each proposed factor of a functional or non-functional matrix analysis may be chosen by the user to indicate whether it constitutes a requisite part of any of the plurality of solutions. Subsequent to the user's selection of any of the proposed factors, a score may be generated for each solution. Users may then determine the proper course of action to pursue for the project based on the resultant score of the analysis for each solution. After generating a matrix analysis, the user may choose to store it in the backend database repository by utilizing the save option.

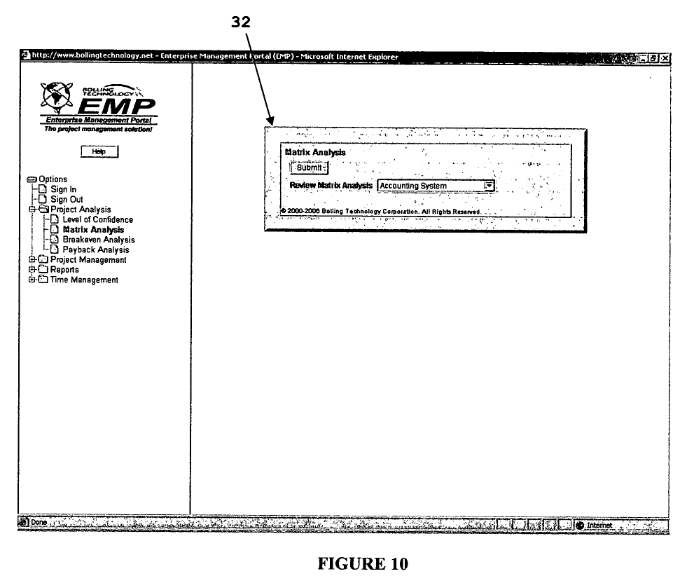

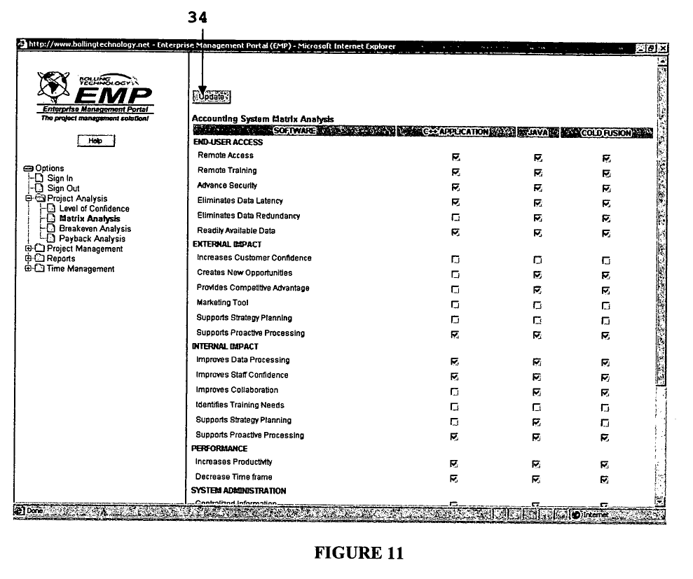

The matrix analysis component 7 of the system 1 shown in FIG. 10 may further comprise a review analysis option 32. The review analysis option may allow users of the system 1 to choose a preexisting matrix analysis to review and/or update 34 (FIG. 11). Users may merely review each proposed solution of a chosen matrix analysis, or may further modify each of the proposed factors and update the score generated for each solution.

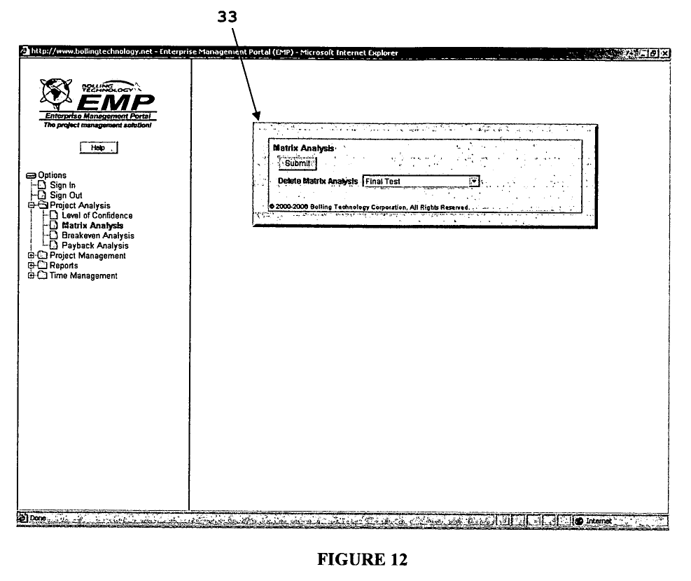

In the embodiment shown in FIG. 12, the matrix analysis component 7 of the system 1 may comprise a delete analysis option 33. The delete analysis option 33 may allow a user to erase a preexisting matrix analysis from the system's 1 database repository.

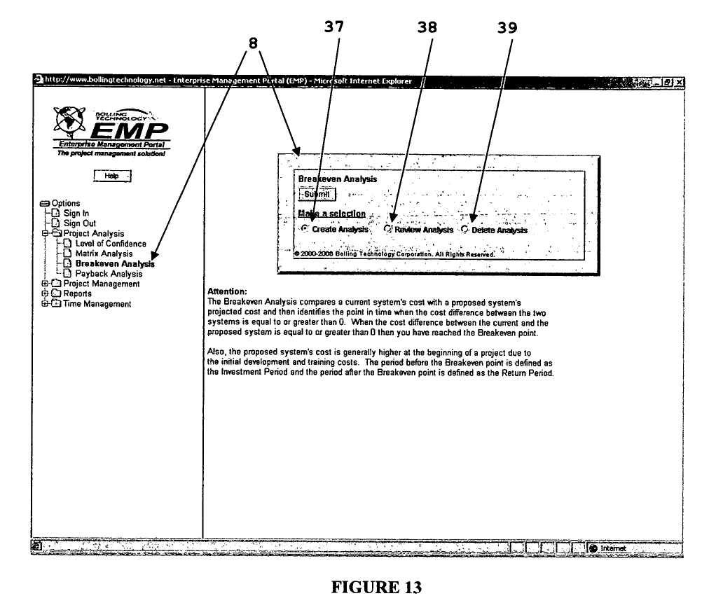

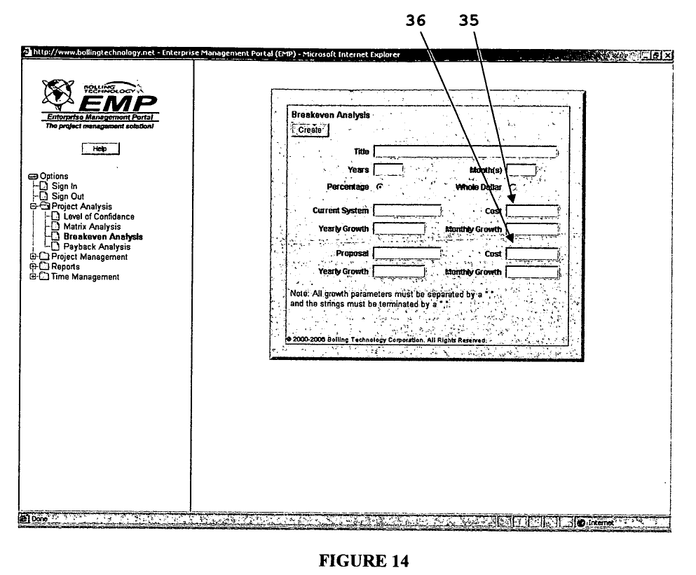

FIGS. 13 and 14 depict specific embodiments of the breakeven analysis component 8. In FIG. 14, this component compares a current system's cost 35 with a proposed system's cost 36 and calculates the point in time when the cost difference between the two projects is equal to or greater than zero (i.e. the breakeven point). The breakeven analysis component 8 provides an excellent economic justification method for determining a proposed solution's return on investment. A proposed system's cost 36 is generally higher at a project's inception due to the initial development and training costs. The period before the breakeven point may be referred to as the investment period and the period after may be referred to as the return period.

In FIG. 13, the breakeven analysis component 8 of the system 1 may comprise a create analysis option 37, review analysis option 38, and delete analysis option 39. The create analysis option 37 of the breakeven analysis component 8 may allow users of the system 1 to determine the breakeven point upon entering criteria for the current system and a proposed system. These criteria are shown in FIG. 14, and may include, but are not limited to, the total number of years and/or months that will be used to determine the breakeven point, the current system's cost, the current and proposed system's yearly growth rate as a percentage or whole dollar amount, the current and proposed system's monthly growth rate as a percentage or whole dollar amount, and the proposed system's cost. In certain embodiments, after generating a breakeven analysis, the user may choose to store it in the backend database repository by utilizing the save option.

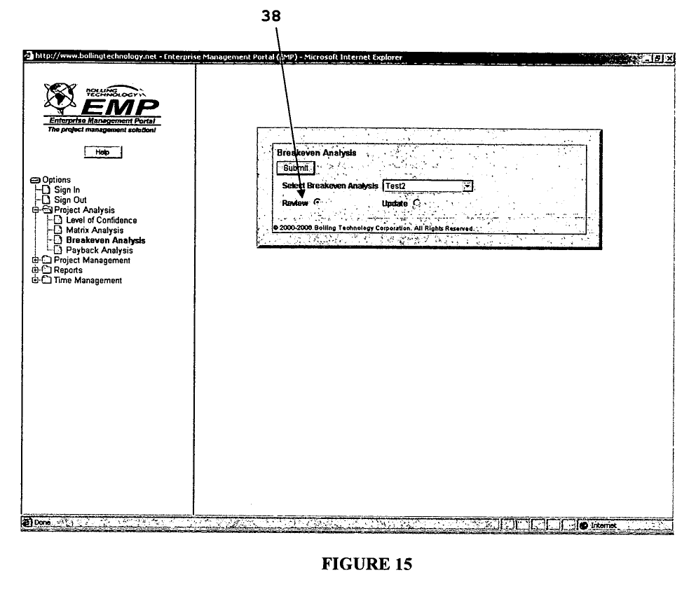

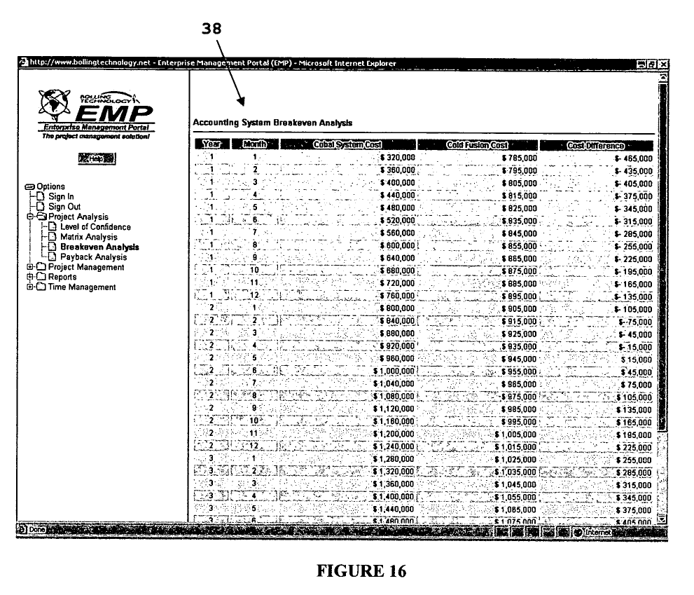

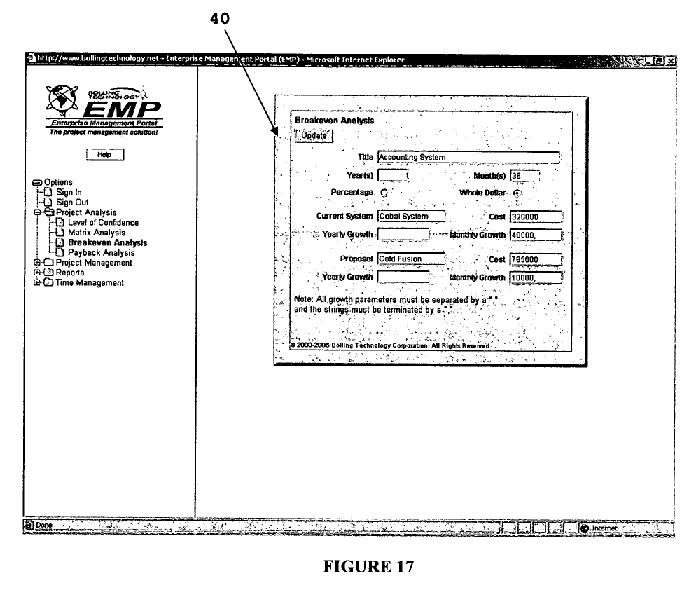

As shown in FIGS. 15-17, the review analysis option 38 of the breakeven analysis component 8 may allow users of the system 1 to view a preexisting breakeven analysis, including the aggregate current system and proposed system costs over the years and/or months, as determined by, for example, the yearly and/or monthly growth rate, and the cost difference. In one embodiment, the cost difference for the year and/or month during which the breakeven point is reached may be specially marked. Users may also use the update option 40 shown in FIG. 17 to make changes to a preexisting breakeven analysis, and then view the results.

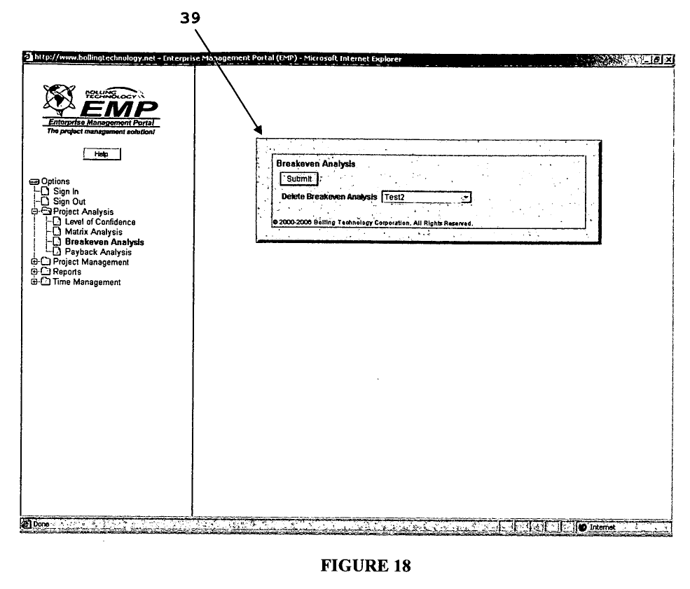

The breakeven analysis component 8 of the system 1 provides for a delete analysis option 39, as shown in FIG. 18. The delete analysis option 39 may allow a user to erase a preexisting breakeven analysis from the system's 1 database repository.

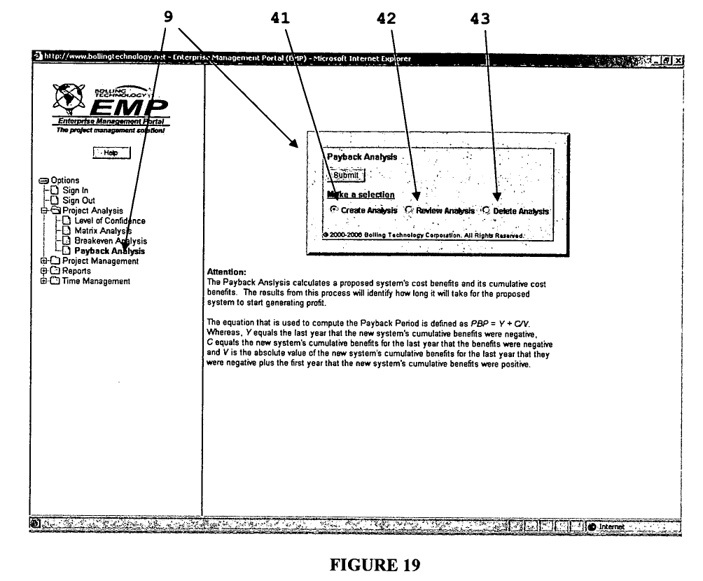

The payback analysis component 9 shown in FIG. 19 may calculate a proposed system's cost benefits and its cumulative cost benefits over a period of time. The results of a payback analysis may be indicative of the length of time it will take for a proposed system to actually generate profit. In certain embodiments, the mathematical equation used to compute the payback period may be defined as PBP=Y+C/V, where Y is the last year that the new system's cumulative benefits are negative, C equals the new system's cumulative benefits for the last year that the benefits were negative, and V is the absolute value of the new system's cumulative benefits for the last year they were negative plus the first year that the new system's cumulative benefits were positive.

The payback analysis component 9 of the system 1 may comprise a create analysis option 41, review analysis option 42, and delete analysis option 43.

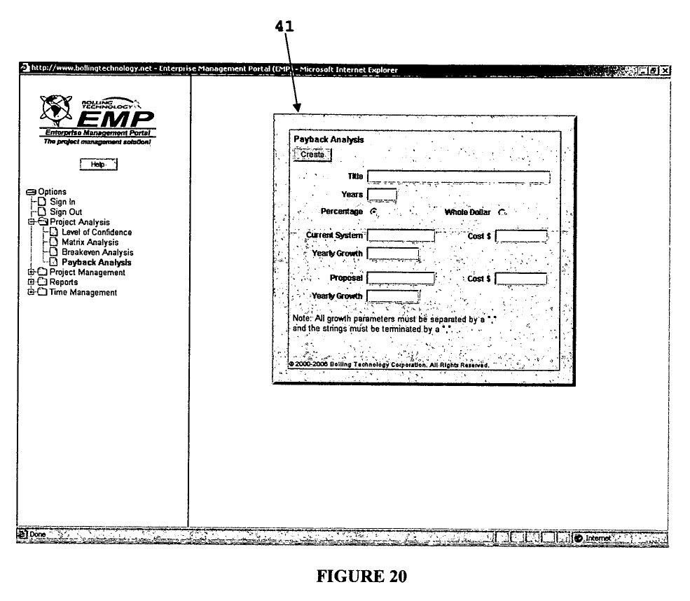

In FIG. 20, the create analysis option 41 of the payback analysis component 9 may allow users of the system 1 to determine the expected cost benefits of an investment over a length of time and calculates the payback period. The create analysis option 41 may require the user to enter several criteria such that the payback period and cost benefits can be calculated. These criteria may include, but are not limited to, the total number of years that will be used to determine the payback period, the current system's cost, the current and proposed system's yearly growth rate as a percentage or whole dollar amount, and the proposed system's cost. In certain embodiments, after generating a payback analysis, the user may choose to store it in the backend database repository by utilizing the save option.

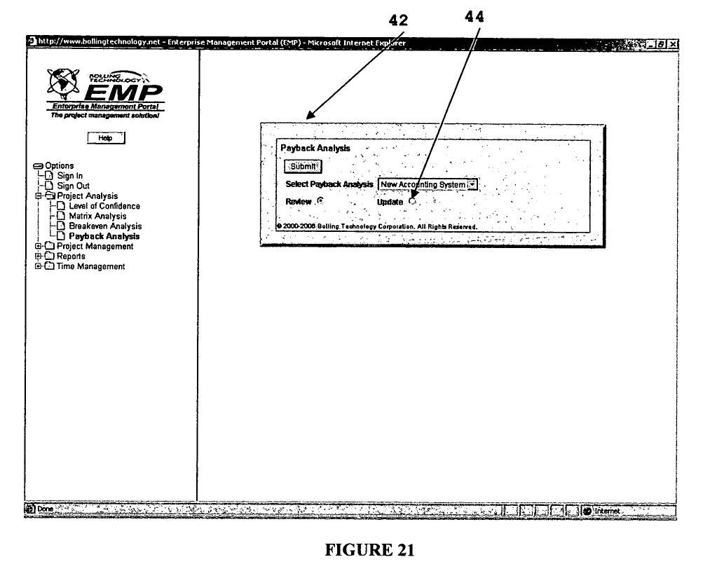

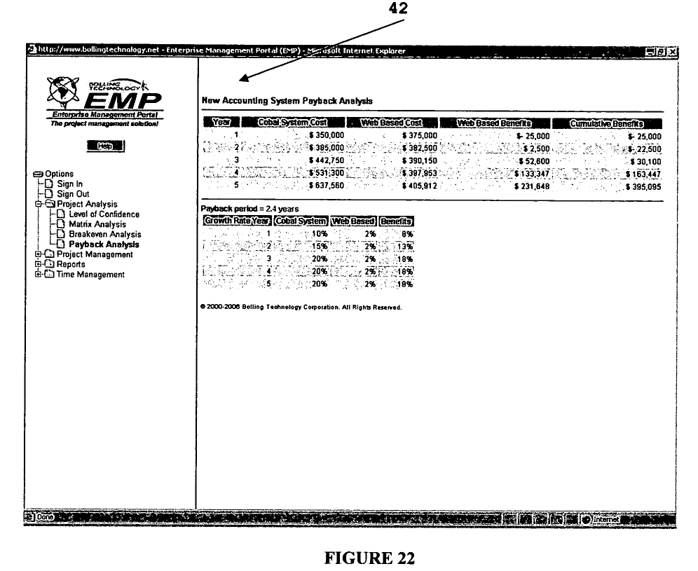

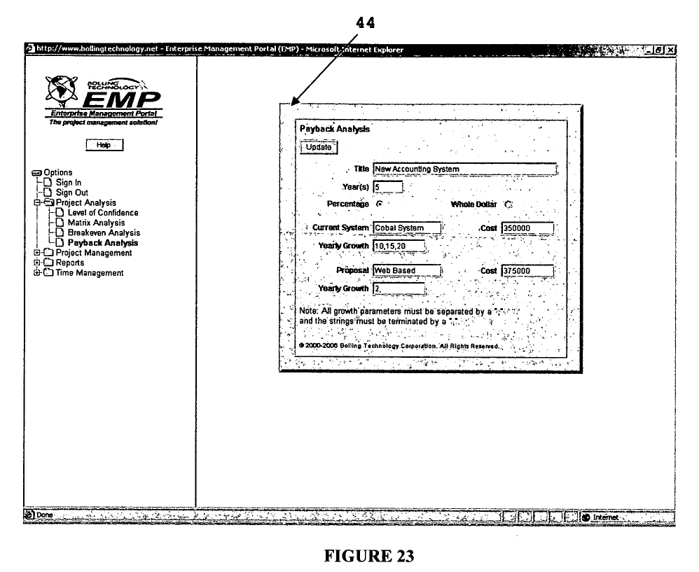

The review analysis option 42, shown in FIGS. 21 and 22, of the payback analysis component 9 may allow users of the system 1 to view a preexisting payback analysis, including the aggregate current system and proposed system costs over the years, as determined by the yearly growth rate, the proposed system benefits, and the cumulative benefits. The payback point when the proposed system actually generates positive cumulative benefit is displayed. Users may also use the update option 44 (FIG. 23) to make changes to a preexisting payback analysis, and then view the results by accessing the review analysis option 42.

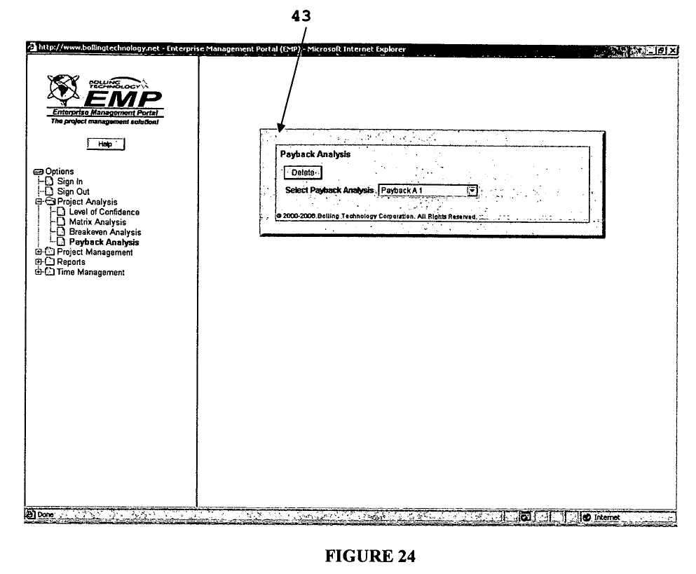

The payback analysis component 9 of the system 1 shown in FIG. 24 may comprise a delete analysis option 43. The delete analysis option 43 may allow a user to erase a preexisting payback analysis from the system's 1 database repository.

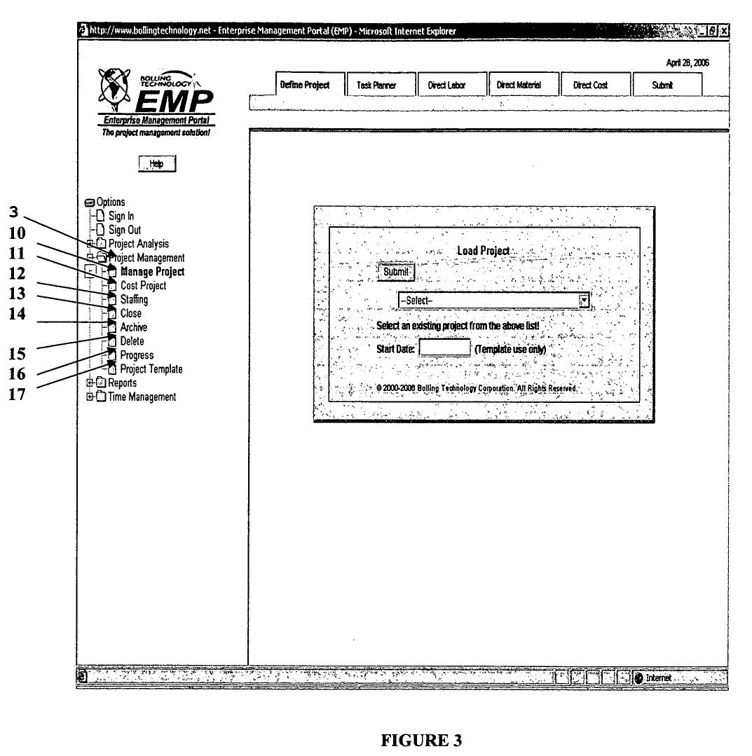

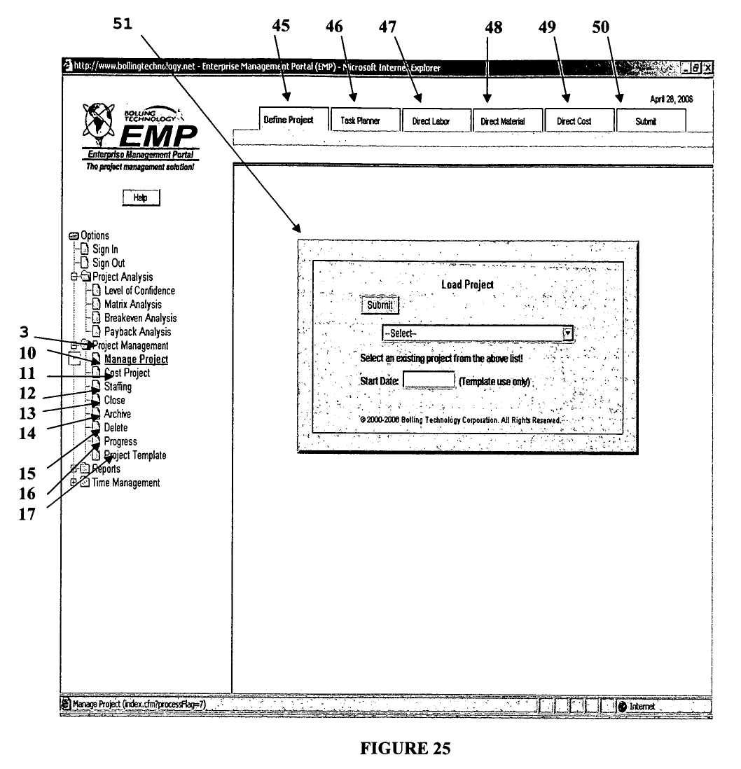

As shown in FIGS. 3 and 25, the project management feature 3 of the system 1 may comprise, but is not limited to, a project definition component 10, a cost determination component 11, a staffing component 12, a close component 13, an archive component 14, a delete component 15, a project progress component 16, and a project template component 17.

The project definition component 10 of the project management feature 3 may comprise a load project component 51, define project component 45, a task planner component 46, a direct labor component 47, a direct material component 48, a direct cost component 49, and a submit component 50.

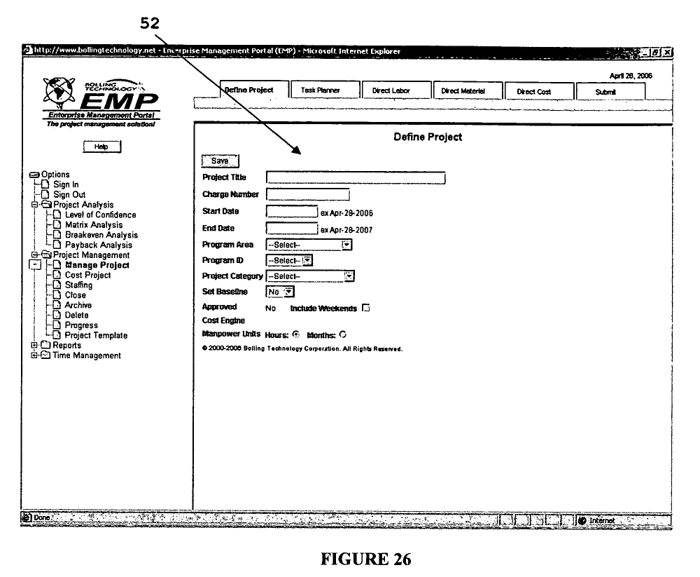

The define project component 45 may allow the user to either load a preexisting project using the load project component 51, or define a new project using the define project component 52 (FIG. 26). The user may load a preexisting project by selecting a project from the selection field and activating the submit option. The user may also define a new project using the define project component 52 by entering one or more inputs including, for example, a project title, a charge number, a start date, an end date, a program area, a program identification (ID), a project category, a schedule type, a unit; and possibly choosing the baseline option, and/or the approval field. The project title field may used to define the name of the project from start to completion. In certain embodiments, the project's title is not used as the database repository's primary key and can be altered at any time during a project's life cycle. The charge number field may be used to define a project's accounting charge number. In certain embodiments, this charge number value may directly correlate with the accounting charge number that is assigned by the user's accounting system. The start date field may define the project's start date. The end date field may define the project's end date. The program area may specifically identify the external program under which a project is being managed. The program ID may define the specific program ID that is assigned to the project by a user's program manager. The project category may define the project's specific type and may be used, for example, to perform confidence level analysis. The set baseline option may indicate whether a baseline has been set for a project. The approval field may indicate whether a project was reviewed and approved by an appropriate user's manager. The cost engine field identifies the cost engine that was invoked to generate a project's cost proposal. The units field may be used to set the manpower units for a project (e.g., hours, months). The schedule type field may allow a user to choose whether to include weekends.

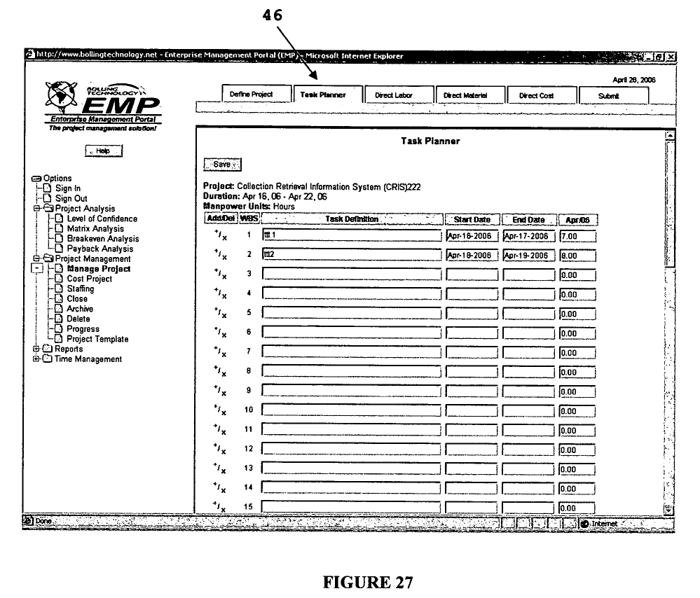

In FIG. 27, the task planner component 46 of the project definition component 10 may allow the user to define one or more tasks for a newly defined or loaded project. The user may then save the tasks to the database repository by invoking a save option. Each task planner component 46 may comprise an add option and a delete option, for allowing the addition and deletion of entries from the task planner, respectively. In one embodiment, a task definition field may define a project's tasks for execution during a project's life cycle. In another embodiment, a start date field may define the task's start date. An end date field may be used to define the task's end date. The length of time (e.g., data) field may receive numeric entries. The matrix size may be determined by the project's start and end dates. If improper data is entered into the length of time field, an exception error may be generated and the user will not be able to invoke the save option until the source of error for the exception is corrected.

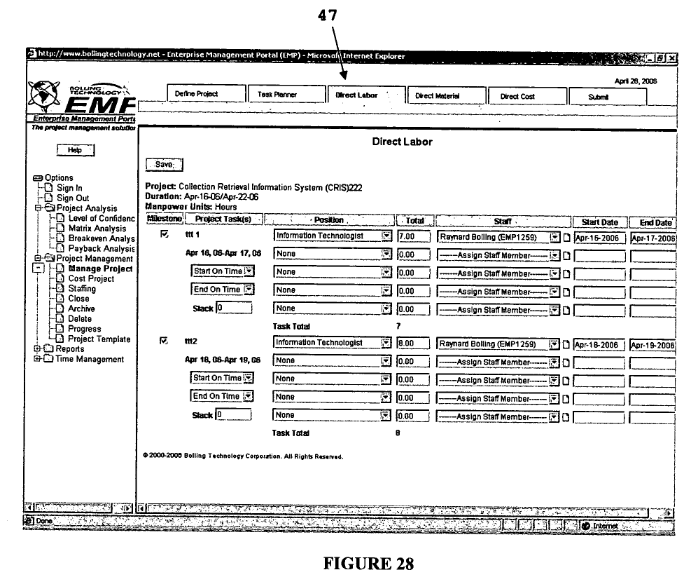

The direct labor component 47 of the project definition component 10 shown in FIG. 28 may allow a user to assign manpower usage to each specific task of a project. Further, users can utilize the direct labor component 47 to assess a variety of data including, but not limited to, checking a staff members' availability, identifying a project's milestones, and calculating task slack time. The direct labor component 47 may comprise, but is not limited to, a save option, a milestone field, a project task, a start indicator, an end indicator, a slack field, a position field, a task total, a staff field, a check availability option, a start date and an end date. The milestone field may be used to identify a project's milestones. The project task identifies each task associated with the project for which the direct labor component 47 was invoked. The start indicator may be used to identify whether a task will start on time. The end indicator may be used to identify whether a task will end on time. The slack field may indicate whether this task's start and end dates are flexible and, if so, how much. The position field may be used to identify the type of position/expertise that is necessary to execute the task. The task total field may be used to identify the manpower usage allocated to each task. The staff field may be used to assign a specific staff member to a specific task. In certain embodiments, managers can check staff members' availability by invoking the check availability option adjacent to the staff field. The start and end date for each task is displayed and may be altered. The user may invoke the save option at anytime to store the task data into the database repository.

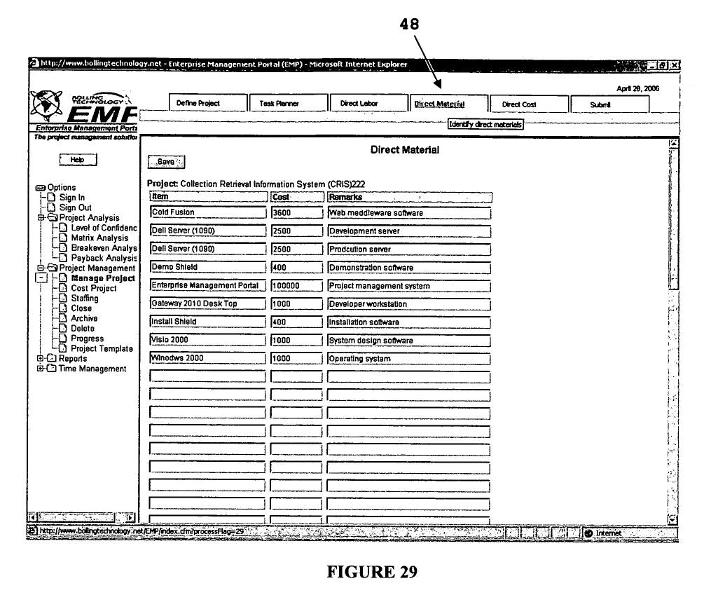

As depicted in FIG. 29, the direct material component 48 of the project definition component 10 may allow the user to identify any materials associated with or necessary to complete a project. The direct material component 48 may comprise a save option and a plurality of items, costs, and remarks for each material. The items field may be used to identify the type of material needed. The costs field may identify the whole dollar cost for the material. A description of the material may be included in the remarks field.

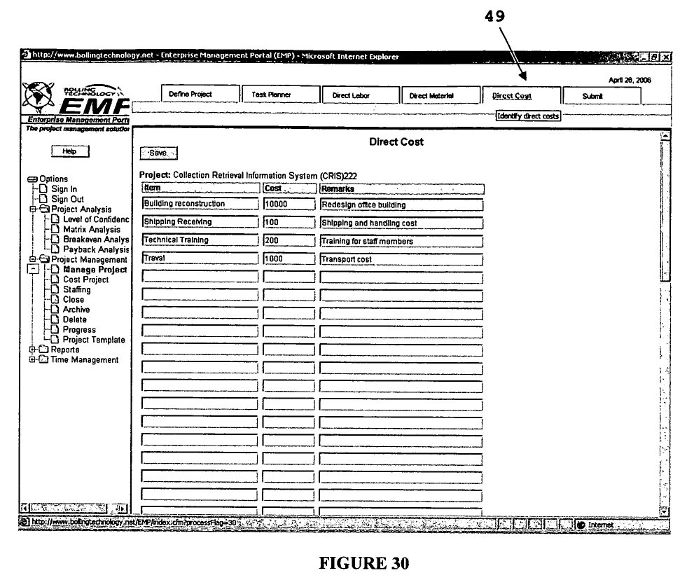

The direct cost component 49 of the project definition component 10 shown in FIG. 30 is similar to the direct material component 48 but instead may allow the user to identify the miscellaneous purchases necessary to complete a project (i.e., travel and staff training). The direct cost component 49 may comprise a save option and a plurality of items, costs, and remarks for each direct cost purchase. The items field may be used to identify the type of purchase. The costs field identifies the whole dollar cost of the purchase. A description of the purchase may also be included in the remarks field.

The submit component 50 of the project definition component 10 (FIG. 25) may allow the user to submit a newly defined project or loaded project to the database repository.

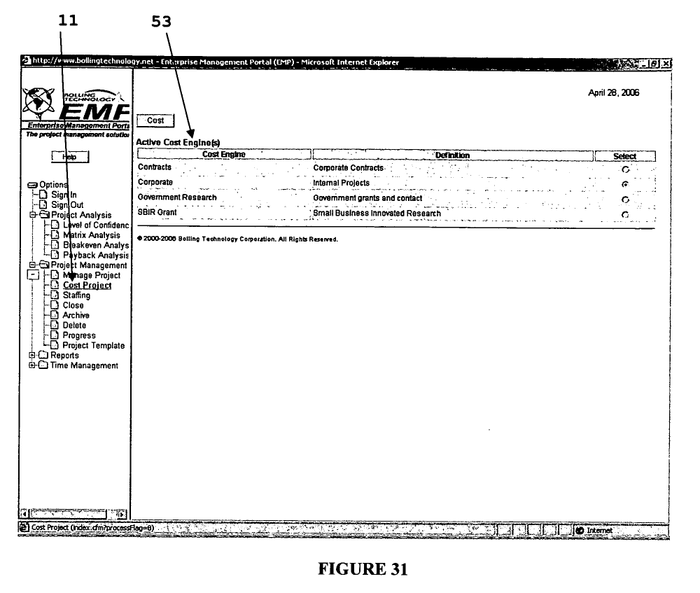

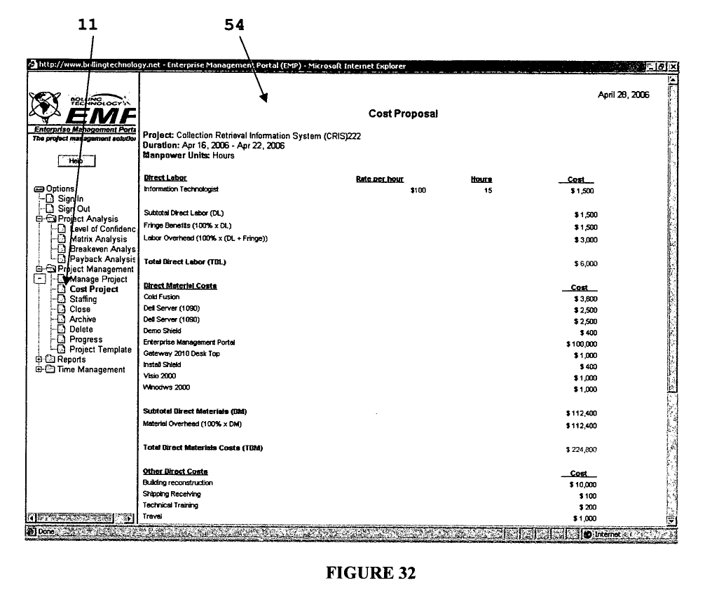

In FIGS. 31 and 32, the cost determination component 11 of the project management feature 3 may allow a user to immediately identify the bottom line costs associated with executing a project. The cost determination component 11 may comprise an active cost engine component 53 and a cost proposal component 54. The active cost engine is the implementation of various known cost methods. A user with administrative type privileges may implement and configure the various cost methods. Once a project has been loaded or defined using the load project component 51 or define project component 52, a user may then select one of the cost methods implemented in the active cost engine component 53. After invoking one of the cost methods, a cost proposal component 54 may be activated and displayed for the user's approval. The user responsible for approving project cost proposals may then be notified electronically and may be provided access to the cost proposal for review. Subsequently, the user who submitted the cost proposal may be notified as to whether it was approved.

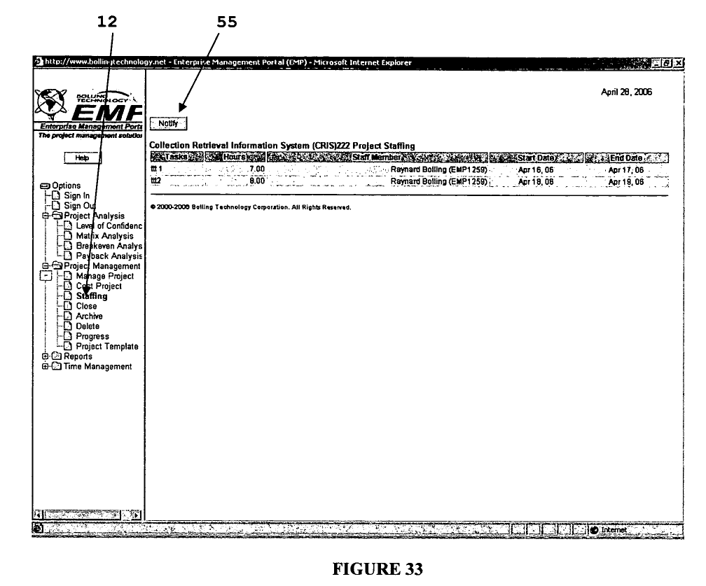

The staffing component 12 of the project management feature 3 in FIG. 33 may provide users with the ability to send task assignment information to each project's team member via electronic communication. In certain embodiments, a user may be required to first load or define a project prior to invoking the staffing component. The staffing component 12 may provide a notification component 55. Upon invoking the notification component 55, task schedule information may be sent to all participating employees, users, or members of a respective project.

The close component 13 of the project management feature 3 shown in FIG. 25 may provide a method for users to close an existing or newly defined project.

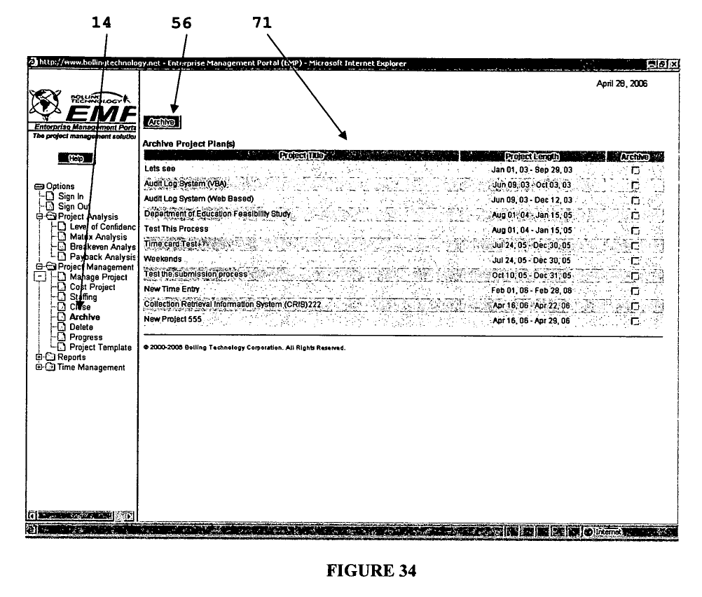

In FIG. 34, the archive component 14 of the project management feature 3 may comprise a project list 71 and an archive option 56. Once a project is complete, for example, a user may use the archive option 56 to place a project in archive mode. In certain embodiments, the user must first select one or more projects from the project list 71 to place in archive mode. In other embodiments, projects in archive mode may not be retrievable using the system's 1 components. In such cases, the archived projects may be retrieved by users with special administrative privileges.

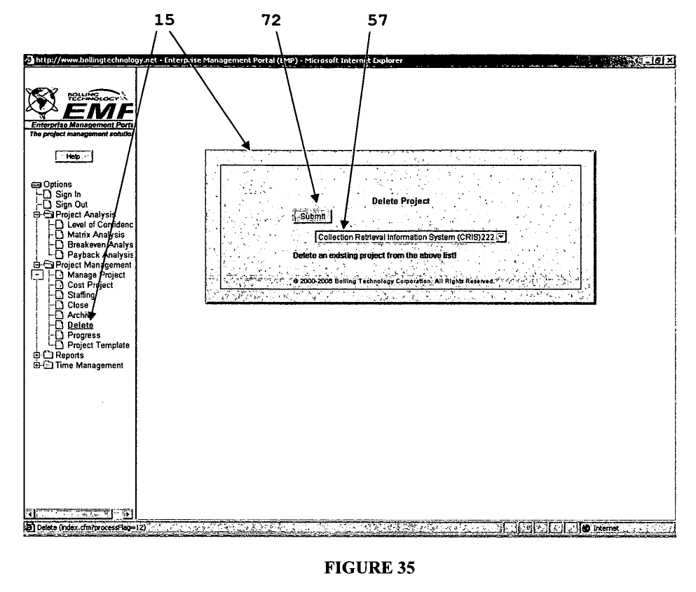

The delete component 15 of the project management feature 3 shown in FIG. 35 may comprise a submit option 72 and a selection field 57. The delete component 15 may allow a user to delete a particular project by first choosing it from the selection field 57 and then invoking the submit option 72.

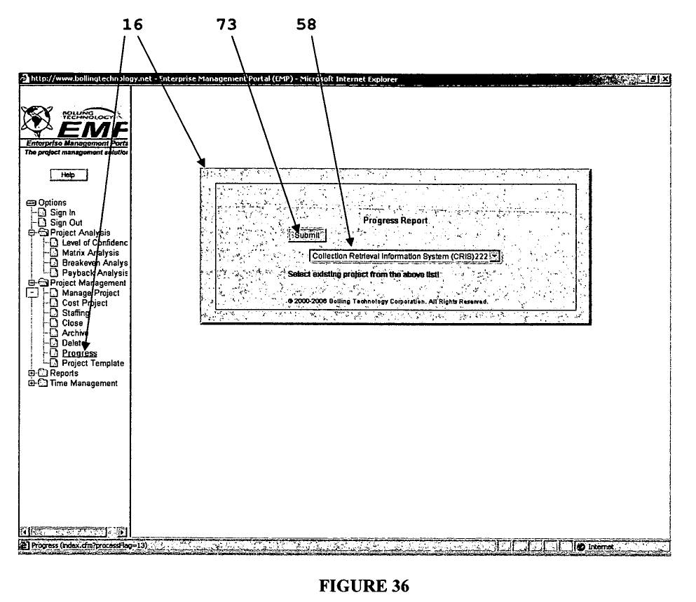

In FIG. 36, the project progress component 16 of the project management feature 3 may comprise a submit option 73 and a selection field 58. The project progress component 16 may allow users to identify numerous variables including, but not limited to, the completion percentage for each task, the start date, the end date, the staff members assigned to each task, and staff members' daily progress reports. A user may also view the project completion percentage.

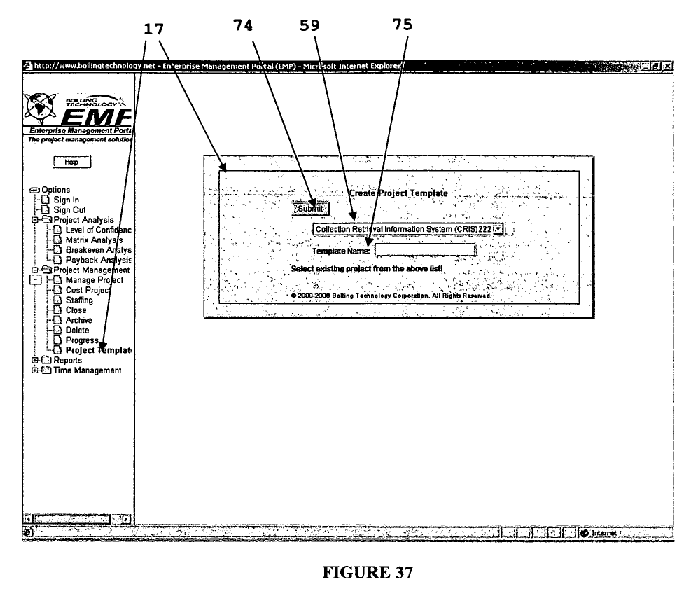

The project template component 17 of the project management feature 3 shown in FIG. 37 may comprise a submit option 74, a selection field 59, and a template field 75. The project template component may allow users to reuse existing projects rather than creating new projects and redefining all of the respective fields and components. A user may select a desired project from the selection field 59, enter a template name into the template field 75 to identify the new project, and invoke the submit option 74.

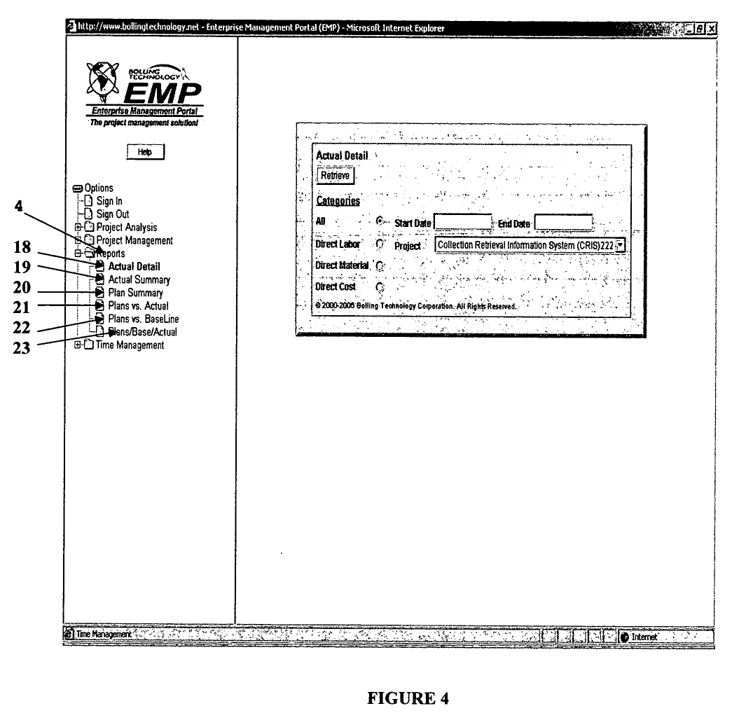

With reference to FIG. 4, the report generating feature 4 of the system 1 may comprise an actual detail component 18, an actual summary component 19, a plan summary component 20, an analysis component for comparing a plan summary against an actual summary 21, an analysis component for comparing a plan summary against a baseline summary 22, and an analysis component for comparing a plan summary, a baseline summary, and an actual summary 23.

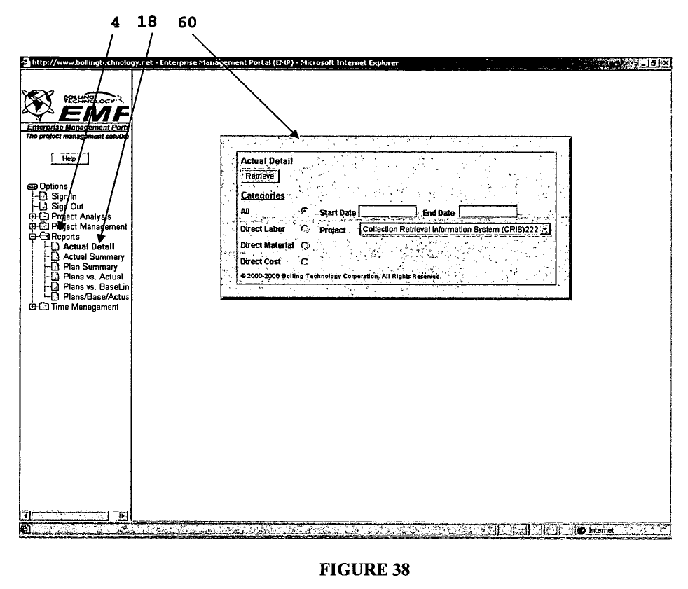

The actual detail component 18 shown in FIG. 38 may allow a user to retrieve detailed expenditure data and may provide a retrieval component 60 and an actual detail report. The retrieval component 60 may comprise categories, a start date, an end date, and a project field. The categories may be used to define the data products that will be displayed to the user. In certain embodiments, a user may choose the category: “All” to display all actual detail expenditures, “Direct Labor” to display only direct labor expenditures, “Direct Material” to display only direct material expenditures, or “Direct Cost” to display only direct cost expenditures. The start date may define the report's start date. The end date may define the report's end date. Report data may be generated and displayed within the start and end dates. The project field may be used to define the target project of interest for which data will be retrieved and displayed.

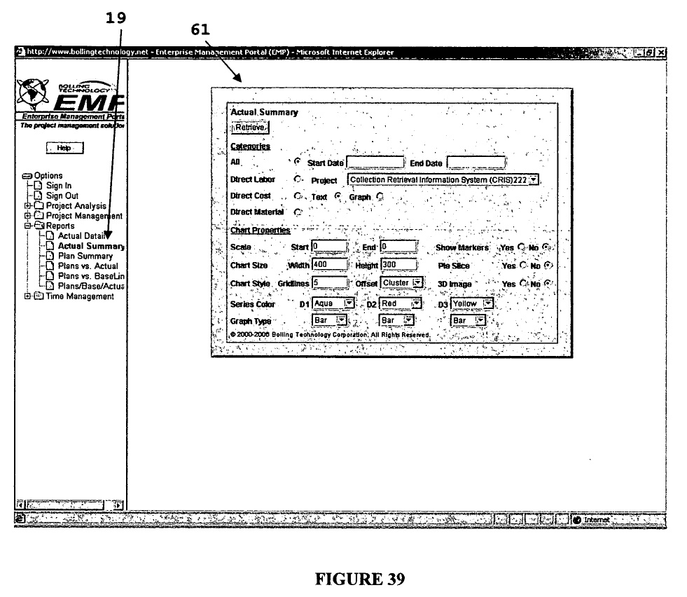

As shown in FIG. 39, the actual summary component 19 may allow a user to retrieve summary expenditure data during and after a project's execution. Summary expenditure data may be viewed, for example, in tabular or graphical form. The actual summary component 19 may provide a retrieval component 61 and an actual graphical and non-graphical summary report. The retrieval component 61 may comprise categories, a start date, an end date, a project field, a text option, a graph option, a graph display type option, and chart properties.

The categories may be used to define the data products that will be displayed to the user. A user may choose the category: “All” to display all actual detail expenditures, “Direct Labor” to display only direct labor expenditures, “Direct Material” to display only direct material expenditures, or “Direct Cost” to display only direct cost expenditures. The start date may define the report's start date. The end date may define the report's end date. Report data may be generated and displayed within the start and end dates. The project field may define the target project of interest for which data will be retrieved and displayed. The text option may instruct the retrieval component 61 to generate a non-graphical summary report. The graph option may instruct the retrieval component 61 to generate a graphical summary report. The chart properties may include, but are not limited to, scale fields, a markers option, chart size fields, a pie slice option, a grid lines field, an offset, a three-dimensional image option, a series color field, and a graph display type option. The scale fields may be used to define a graphical summary report's start and end data points. The markers option may instruct the retrieval component 61 to generate a graphical report with markers at each data point. The chart size fields may be used to define a graphical summary report's width and height. The pie slice option may instruct the retrieval component 61 to generate a graphical report displayed as a pie. The grid lines field may indicate the total number of grid lines to be placed on the graph. The offset may instruct the retrieval component 61 whether to offset the data series. The three-dimensional image option may instruct the EMP application to generate a three-dimensional (3D) graph rather than a flat two-dimensional (2D) graph. The series color field may be used to alter the color of a data series. The graph display type option may be used to define the individual data series' graph types. Some available graph types include, but are not limited to, bar graphs, curve graphs, line graphs, and pie graphs.

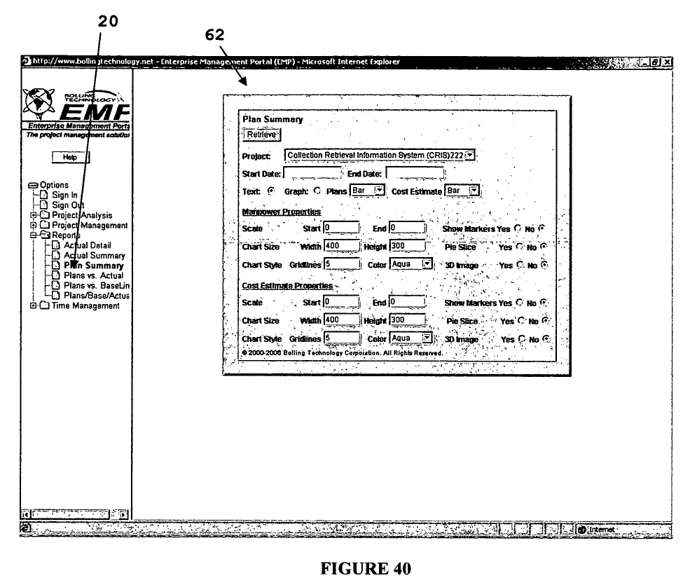

As shown in FIG. 40, the plan summary component 20 may allow a user to retrieve project summary information using a retrieval component 62 that displays the information using an actual graphical or non-graphical summary report. The retrieval component 62 may comprise a project field, a start date, an end date, a text option, a graph option, a graph display type option, and a plurality of chart properties.

The project field may define the target project of interest for which data will be retrieved and displayed. The start date may define the report's start date. The end date may define the report's end date. Report data is generated and displayed within the start and end dates. The text option may instruct the retrieval component 62 to generate a non-graphical summary report. The graph option may instruct the retrieval component 62 to generate a graphical summary report. Each of the plurality of chart properties may include, but is not limited to, scale fields, a markers option, chart size fields, a pie slice option, a grid lines field, an offset, a three-dimensional image option, a color field, and a graph display type option. The scale fields may be used to define a graphical summary report's start and end data points. The markers option may instruct the retrieval component 62 to generate a graphical report with markers at each data point. The chart size fields may be used to define a graphical summary report's width and height. The pie slice option may instruct the retrieval component 62 to generate a graphical report displayed as a pie. The grid lines field may indicate the total number of grid lines to be placed on the graph. The offset may instruct the retrieval component 62 whether to offset the data series. The three-dimensional image option may instruct the EMP application to generate a three-dimensional (3D) graph rather than a flat two-dimensional (2D) graph. The color field may be used to alter each plotted graph's color. The graph display type option may be used to define the individual data series' graph types. Some available graph types are bar graphs, curve graphs, line graphs and pie graphs.

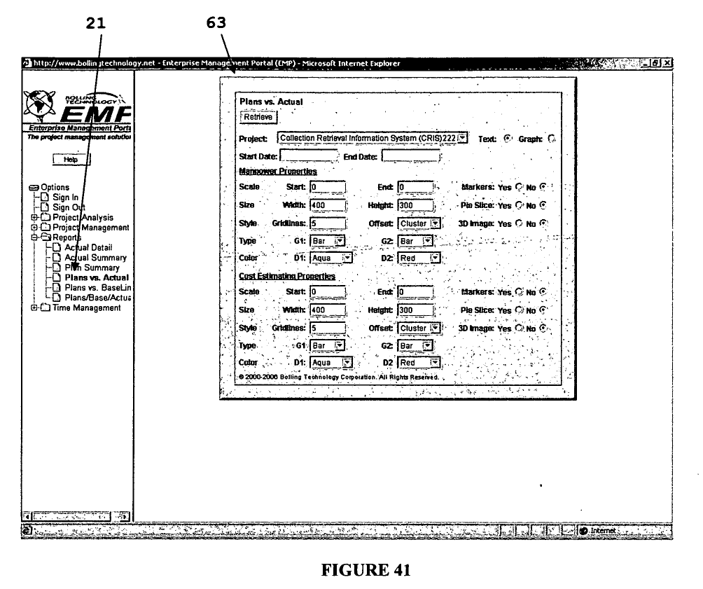

With reference to FIG. 41, the analysis component for comparing a plan summary against an actual summary 21 may allow a user to retrieve planned and actual project summary information using a retrieval component 63 that displays the information using an actual graphical or non-graphical summary report. The retrieval component 63 may comprise a project field, a text option, a graph option, a start date, an end date, a graph display type option, and a plurality of chart properties.

The project field may define the target project of interest for which data will be retrieved and displayed. The text option may instruct the retrieval component 63 to generate a non-graphical summary report. The graph option may instruct the retrieval component 63 to generate a graphical summary report. The start date may define the report's start date. The end date may define the report's end date. Report data is generated and displayed within the start and end dates. Each of the plurality of chart properties may include, but is not limited to, scale fields, a markers option, chart size fields, a pie slice option, a grid lines field, an offset, a three-dimensional image option, a color field, and a graph display type option. The scale fields may be used to define a graphical summary report's start and end data points. The markers option may instruct the retrieval component 63 to generate a graphical report with markers at each data point. The chart size fields may be used to define a graphical summary report's width and height. The pie slice option may instruct the retrieval component 63 to generate a graphical report displayed as a pie. The grid lines field may indicate the total number of grid lines to be placed on the graph. The offset may instruct the retrieval component 63 whether to offset the data series. The three-dimensional image option may instruct the EMP application to generate a three-dimensional (3D) graph rather than a flat two-dimensional (2D) graph. The color field may be used to alter each plotted graph's color. The graph display type option may be used to define the individual data series' graph types. Some available graph types are bar graphs, curve graphs, line graphs and pie graphs.

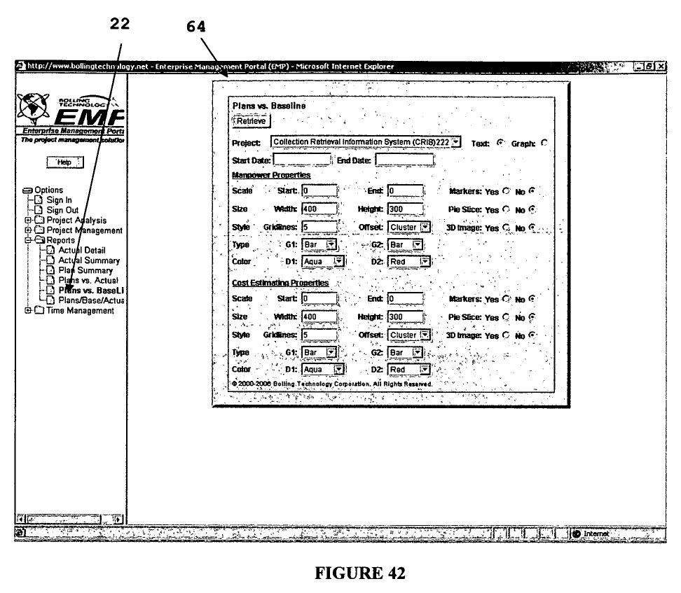

As depicted in the embodiment of FIG. 42, the analysis component for comparing a plan summary against a baseline summary 22 may allow a user to retrieve project plan and baseline summary information using a retrieval component 64 that displays the information using an actual graphical and non-graphical summary report. The retrieval component 64 may comprise a project field, a text option, a graph option, a start date, an end date, a graph display type option, and a plurality of chart properties.

The project field may define the target project of interest for which data will be retrieved and displayed. The text option may instruct the retrieval component 64 to generate a non-graphical summary report. The graph option may instruct the retrieval component 64 to generate a graphical summary report. The start date may define the report's start date. The end date may define the report's end date. Report data is generated and displayed within the start and end dates. Each of the plurality of chart properties may include, but is not limited to, scale fields, a markers option, chart size fields, a pie slice option, a grid lines field, an offset, a three-dimensional image option, a color field, and a graph display type option. The scale fields may be used to define a graphical summary report's start and end data points. The markers option may instruct the retrieval component 64 to generate a graphical report with markers at each data point. The chart size fields may be used to define a graphical summary report's width and height. The pie slice option may instruct the retrieval component 64 to generate a graphical report displayed as a pie. The grid lines field may indicate the total number of grid lines to be placed on the graph. The offset may instruct the retrieval component 64 whether to offset the data series. The three-dimensional image option may instruct the EMP application to generate a three-dimensional (3D) graph rather than a flat two-dimensional (2D) graph. The color field may be used to alter each plotted graph's color. The graph display type option may be used to define the individual data series' graph types. Some available graph types are bar graphs, curve graphs, line graphs and pie graphs.

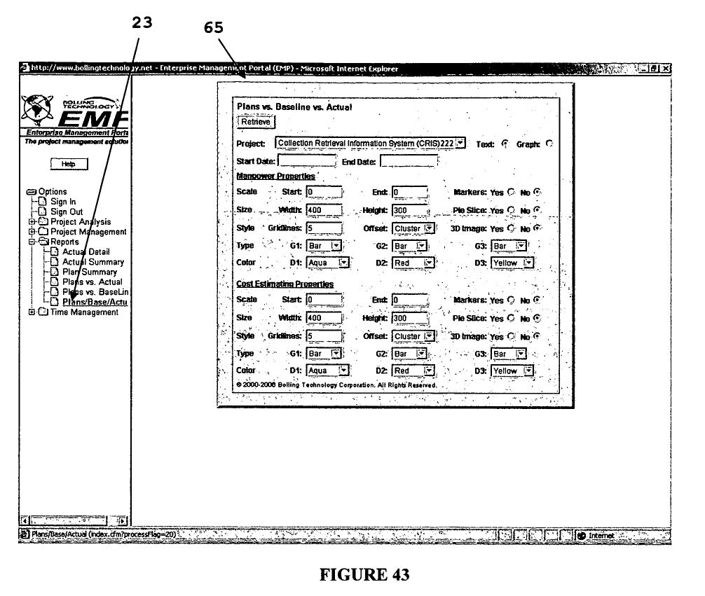

In FIG. 43, the analysis component for comparing plan summary, baseline summary, and actual summary 23 may allow a user to retrieve project plan, baseline, and actual summary information using a retrieval component 65 that displays the information using an actual graphical and non-graphical summary report. The retrieval component 65 may comprise a project field, a text option, a graph option, a start date, an end date, a graph display type option, and a plurality of chart properties.

The project field may define the target project of interest for which data will be retrieved and displayed. The text option may instruct the retrieval component 65 to generate a non-graphical summary report. The graph option may instruct the retrieval component 65 to generate a graphical summary report. The start date may define the report's start date. The end date may define the report's end date. Report data is generated and displayed within the start and end dates. Each of the plurality of chart properties may include, but is not limited to, scale fields, a markers option, chart size fields, a pie slice option, a grid lines field, an offset, a three-dimensional image option, a color field, and a graph display type option. The scale fields may be used to define a graphical summary report's start and end data points. The markers option may instruct the retrieval component 65 to generate a graphical report with markers at each data point. The chart size fields may be used to define a graphical summary report's width and height. The pie slice option may instruct the retrieval component 65 to generate a graphical report displayed as a pie. The grid lines field may indicate the total number of grid lines to be placed on the graph. The offset may instruct the retrieval component 65 whether to offset the data series. The three-dimensional image option may instruct the EMP application to generate a three-dimensional (3D) graph rather than a flat two-dimensional (2D) graph. The color field may be used to alter each plotted graph's color. The graph display type option may be used to define the individual data series' graph types. Some available graph types are bar graphs, curve graphs, line graphs and pie graphs.

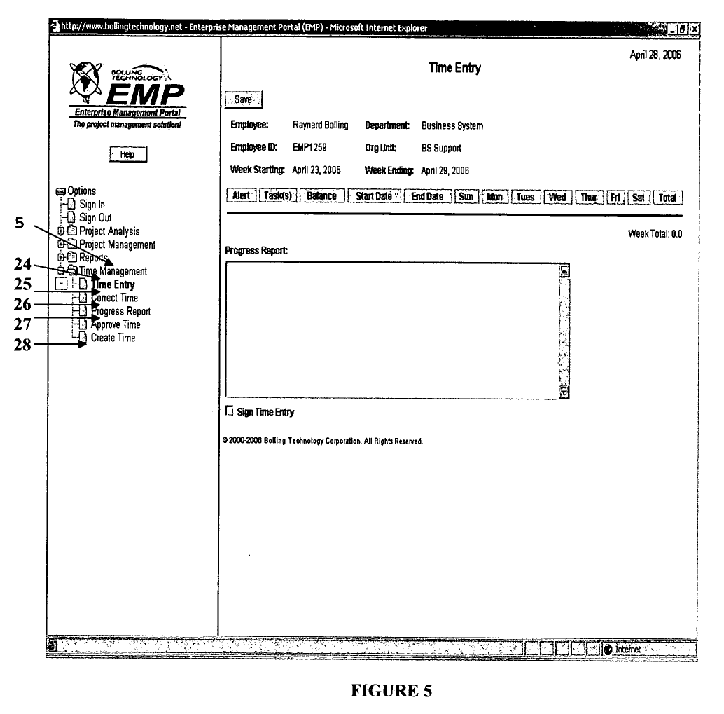

The time generating feature 5 of the system 1 shown in FIG. 5 may comprise a time entry component 24, a correct time entry component 25, a progress report component 26, an approve time component 27, and a create time component 28.

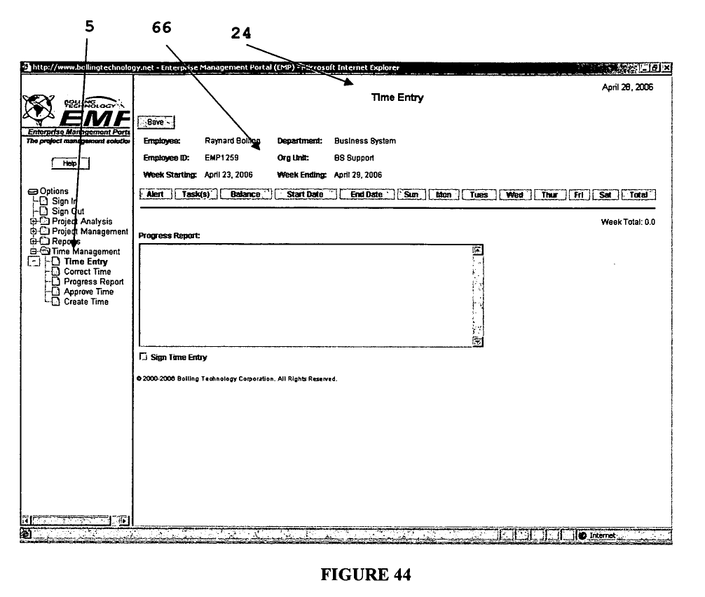

As shown in FIG. 44, the time entry component 24 may allow a user to view and alter time entries for a specific project member or employee, and may comprise a save option, a time entry header 66, an alert, a task, a balance, a start date, an end date, days of week fields, a progress report field, and a signature field. The save option may allow a user to send the data of a time entry to the database repository for storage. The time entry header 66 may display information including, but not limited to, the employee's name, department, identification (ID), organizational unit, and the start and end dates of the week for which time is displayed. The alert field may display any critical notices associated with the task for which the time entry is displayed. A task field may display each task for the employee, for example, for the specific week displayed. A balance field may display the balance of time remaining for the task displayed. The start and end dates display the dates on which a task starts and ends. The days of week fields display the amount of time entered for each task per weekday or weekend by an employee, for example, identified by the time entry header 66. A total time field may display for the user the total amount of time entered for each task in each week for a specific employee, for example. The progress report field may allow a user to enter details regarding the progress of a time entry. The signature field may be utilized by a user as a method of authorizing the time entry by an electronic signature.

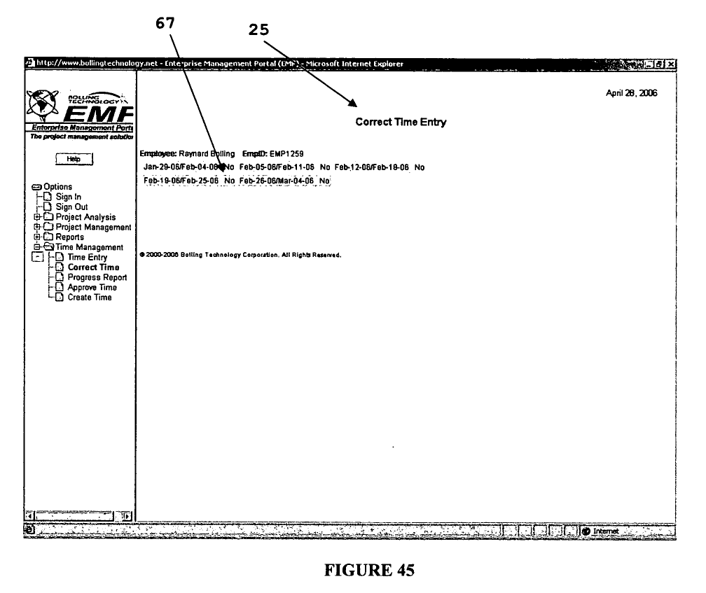

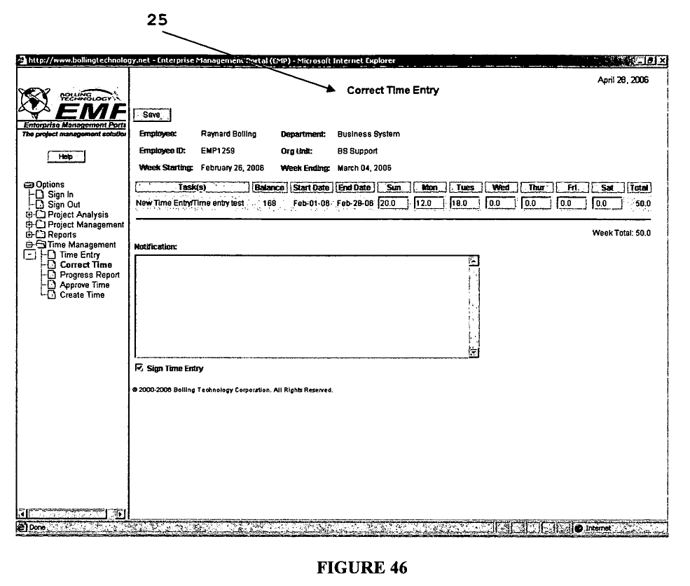

The correct time entry component 25 shown in FIGS. 45 and 46 may allow a user to correct time entries for a specific employee, for example, in a specific week. The correct time entry component 25 provides time entry choices 67, a save option, a time entry header, a task, a balance, a start date, an end date, days of week fields, a notification field, and a signature field. The time entry choices 67 allow a user to choose the week that contains time entries to be corrected. The save option may allow a user to send the corrected data of a time entry to the database repository for storage. The time entry header may display information such as the employee's name, department, identification (i.e. ID), organizational unit, and the start and end dates of the week for which time is displayed. A task field may display each task for the employee, for example, for the specific week displayed. A balance field may display the balance of time remaining for the task displayed. The start and end dates display the dates on which a task starts and ends. The days of week fields display the amount of time entered for each task per weekday or weekend by an employee, for example, identified by the time entry header. The notification field may allow a user to enter information for the employee, for example, who will receive the corrected time entry. The signature field may be utilized by a user as a method of authorizing the time entry by an electronic signature.

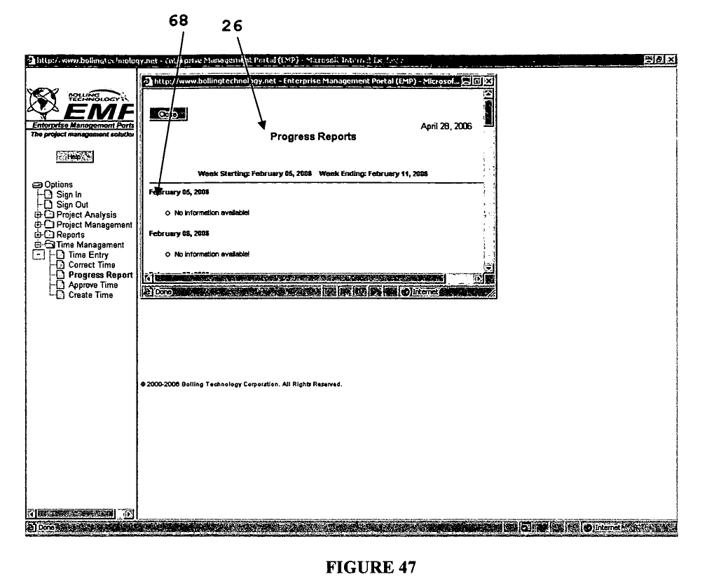

In FIG. 47, the progress report component 26 may display all relevant information regarding time for a specific project, within a certain start and end date, in an itemized details of progress 68. For example, the itemized details of progress 68 may display the notes and comments of employees regarding specific task assignments.

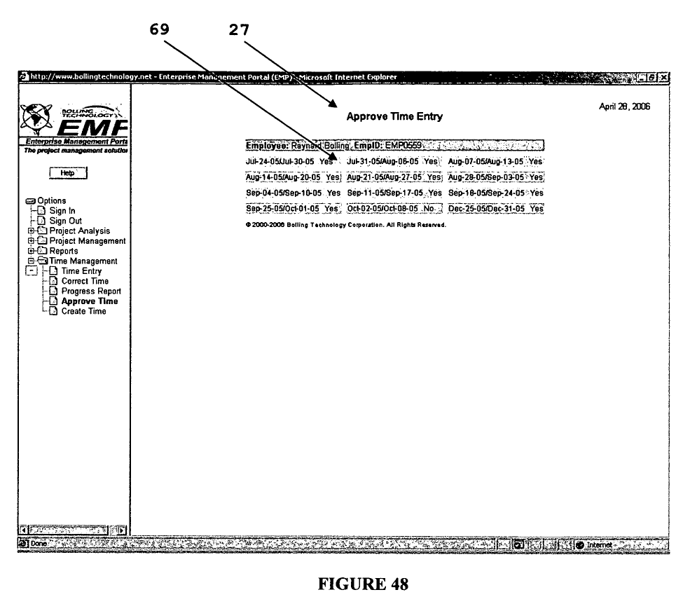

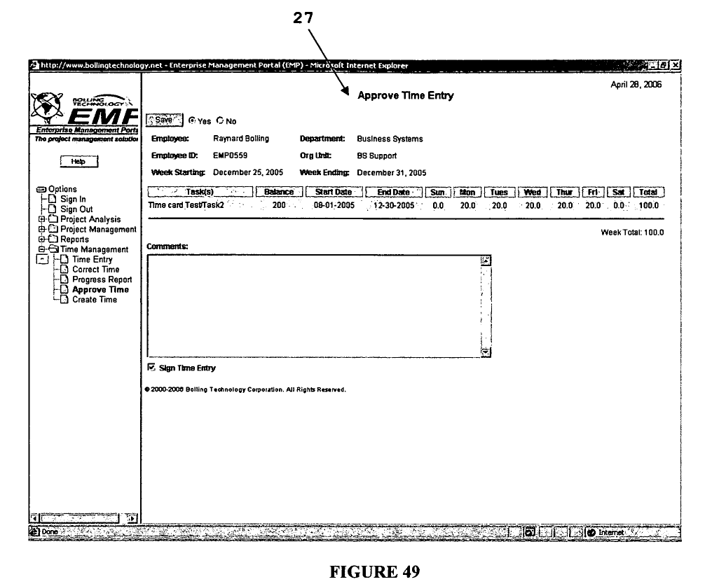

The approve time component 27 in FIGS. 48 and 49 may allow a user, usually with administrative type privileges, the capability to review and approve other users' entered time. The time entry choices 69 allow a user to choose the week that contains time entries to be approved. The approve time component 27 provides a submit option, a staff field, a save option, a time entry header, a task, a balance, a start date, an end date, days of week fields, a comments field and a signature field. The submit option may allow a user to choose the employee, for example, from a staff field for which the user will decide whether to approve time. After the user has decided whether to approve time, the user may invoke the save option to send the data to the database repository. The time entry header may display information such as the employee's name, department, identification (i.e. ID), organizational unit, and the start and end dates of the week for which time is displayed. A task field may display each task for the employee, for example, for the specific week displayed. A balance field may display the balance of time remaining for the task displayed. The start and end dates may display the dates on which a task starts and ends. The days of week fields may display the amount of time entered for each task per weekday or weekend by an employee, for example, identified by the time entry header. The comments field may allow the user determining whether to approve time to enter information for the employee, for example, who will receive the approved time entry. The signature field may be utilized by a user as a method of authorizing the time entry by an electronic signature.

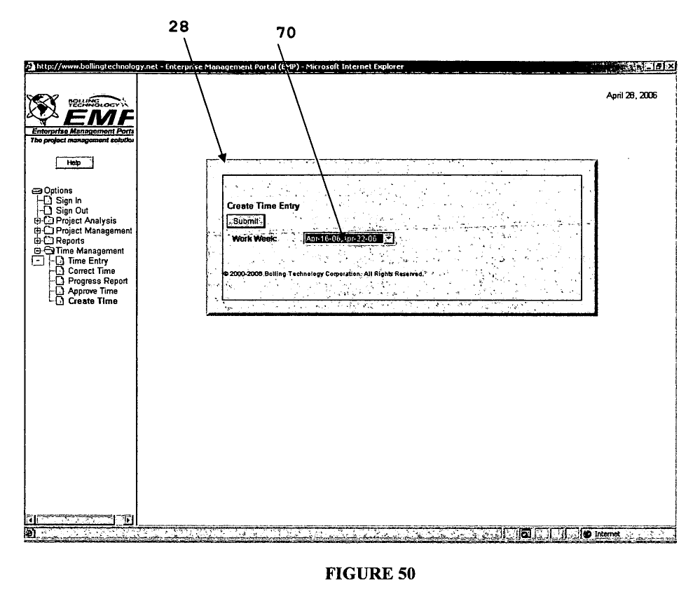

The create time component 28 of FIG. 50 may allow a user to enter time for each task of a specific week. The create time component 28 may comprise a submit option and a week field 70. After choosing a specific week and invoking the submit option, for example, a user may enter the time associated with tasks of that specific week.

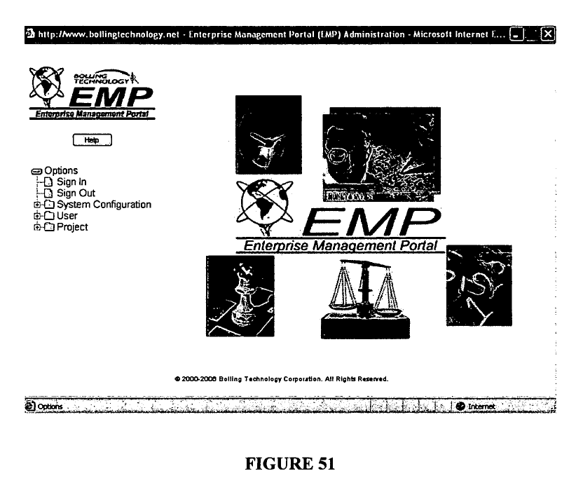

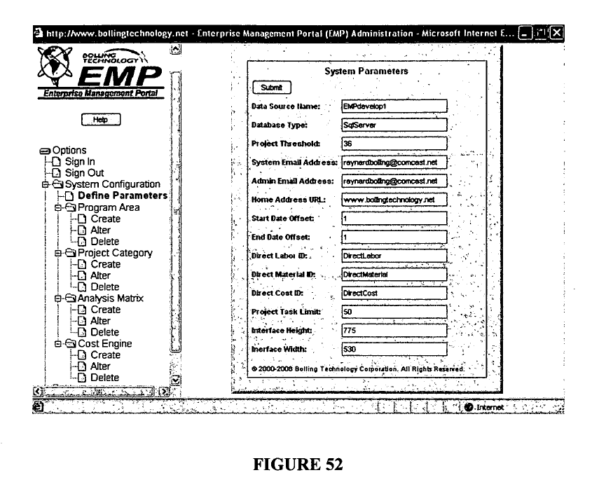

As shown in FIG. 51, the present invention may further comprise embodiments for use by an “administrative” type of user to perform certain tasks including, for example, system configuration, and to manipulate a variety of data and parameters related to, for example, users and projects. FIG. 52 illustrates one embodiment of the present invention. The administrative aspect of the system allows an administrative user to configure the web based management information system. Specifically, the user may adjust a variety of system parameters including, but not limited, data source names, database types, project thresholds, system email addresses, administrative email addresses, home address URLs, start date offsets, end date offsets, direct labor IDs, direct material IDs, direct cost IDs, project task limits, interface heights, and interference widths.

FIG. 51 further illustrates that an administrative user may configure additional system parameters including program areas, project categories, analysis matrices, and cost engines.

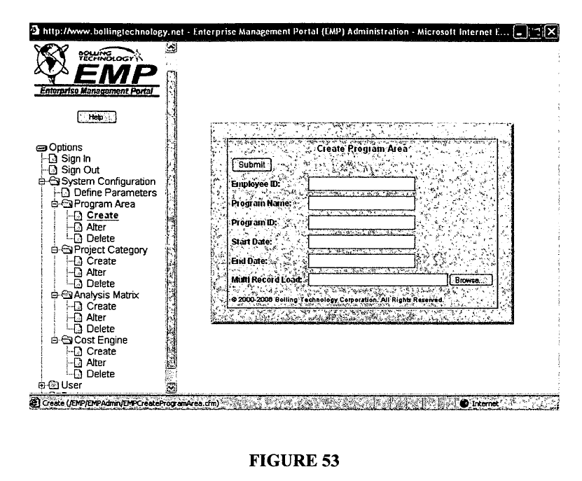

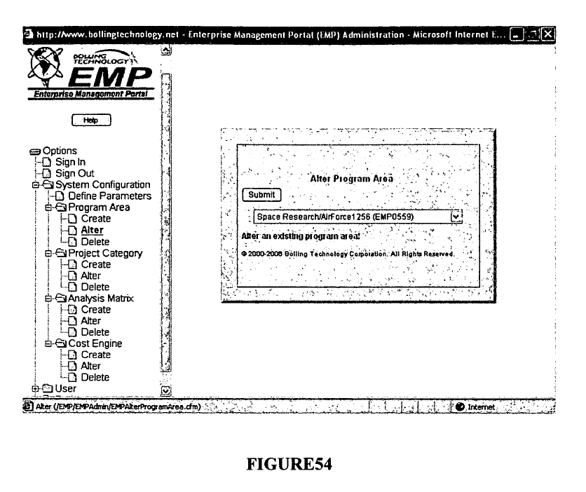

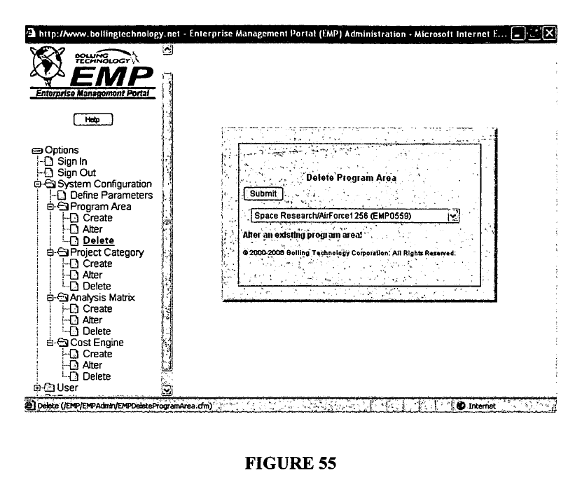

As shown in FIGS. 53-55, an administrative user may create (FIG. 53), alter (FIG. 54), and delete (FIG. 55) program areas. In creating a program area, a user may input various data including, but not limited to, an employee ID, program name, program ID, start date, end date, and a multi record load. The user may utilize a submit option to create the program area.

In the embodiment shown in FIG. 54, an administrative user may alter data and parameters relating to an existing program area by selecting a particular program area from a drop down list of existing program areas, and utilizing a submit option. As shown in FIG. 55, a user may delete an existing program area by utilizing a similar scheme.

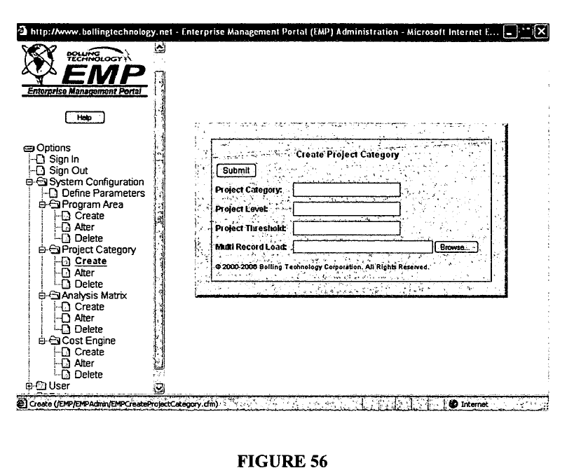

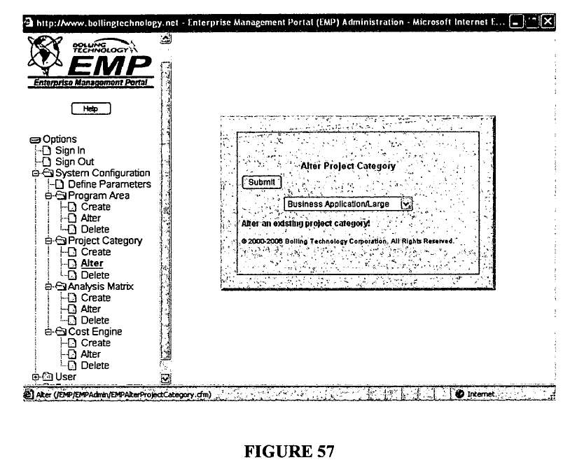

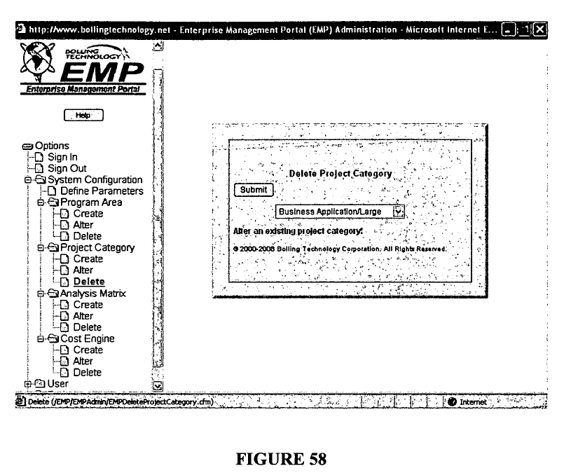

As shown in FIGS. 56-58, an administrative user may create (FIG. 56), alter (FIG. 57), and delete (FIG. 58) program categories. In creating a program category, a user may input various data including, but not limited to, a project category, project level, project threshold, and a multi record load. The user may utilize a submit option to create the program category.

In the embodiment shown in FIG. 57, an administrative user may alter data and parameters relating to an existing program category by selecting a particular program category from a drop down list of existing program categories, and utilizing a submit option. As shown in FIG. 55, a user may delete an existing program category by utilizing a similar scheme.

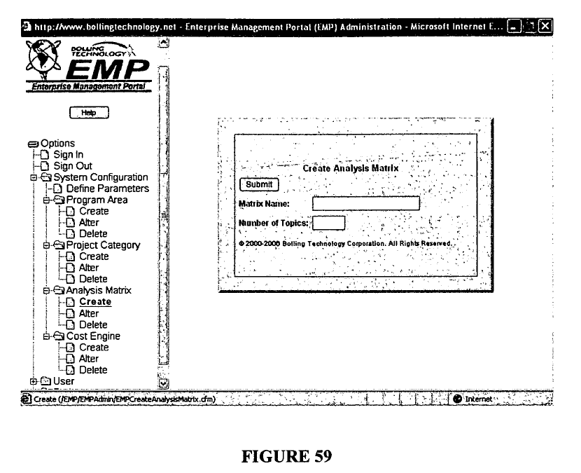

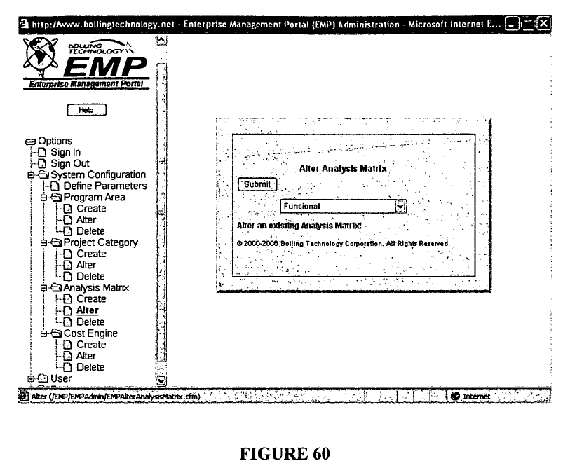

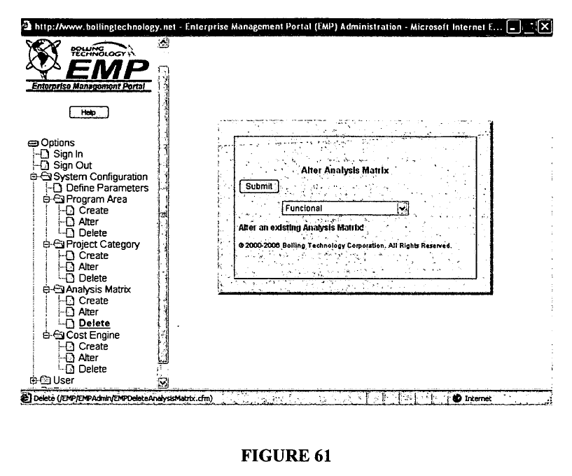

With reference to FIGS. 59-61, an administrative user may create (FIG. 59), alter (FIG. 60), and delete (FIG. 61) analysis matrices. In creating an analysis matrix, a user may input various data including, but not limited to, a matrix name and a number of topics. The user may utilize a submit option to create the analysis matrix.

In the embodiment shown in FIG. 60, an administrative user may alter data and parameters relating to an existing analysis matrix by selecting a particular analysis matrix from a drop down list of existing analysis matrices, and utilizing a submit option. As shown in FIG. 61, a user may delete an existing analysis matrix by utilizing a similar scheme.

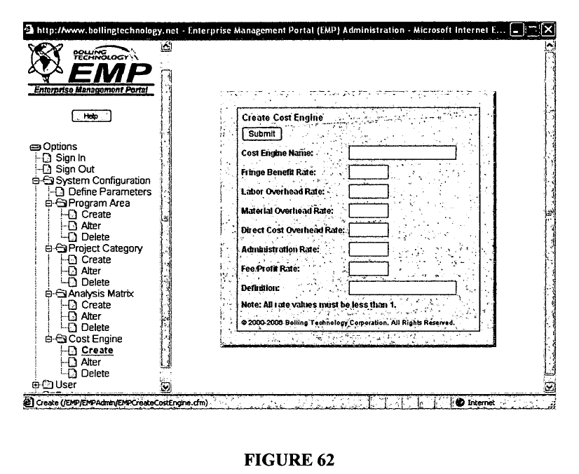

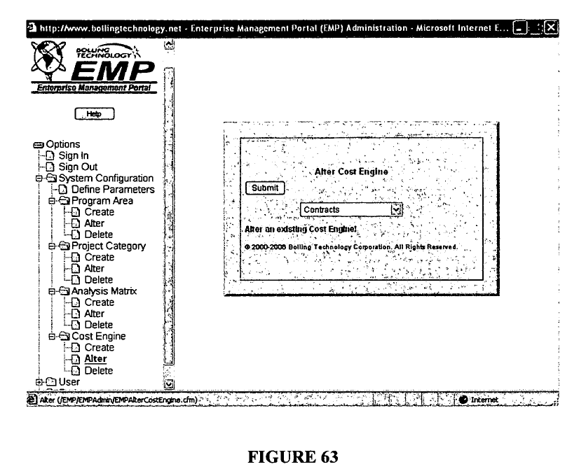

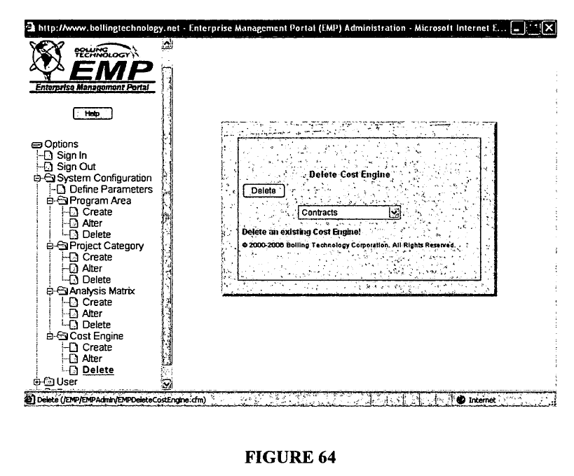

With reference to FIGS. 62-64, an administrative user may create (FIG. 62), alter (FIG. 63), and delete (FIG. 64) cost engines. In creating a cost engine, a user may input various data including, but not limited to, a cost engine name, fringe benefit rate, labor overhead rate, material overhead rate, direct cost overhead rate, administration rate, fee/profit rate, and definition. In one embodiment, the rate values may be less than about 1. The user may then utilize a submit option to create the cost engine.

In the embodiment shown in FIG. 63, an administrative user may alter data and parameters relating to an existing cost engine by selecting a particular cost engine from a drop down list of existing cost engines, and utilizing a submit option. As shown in FIG. 64, a user may delete an existing cost engine by utilizing a similar scheme.

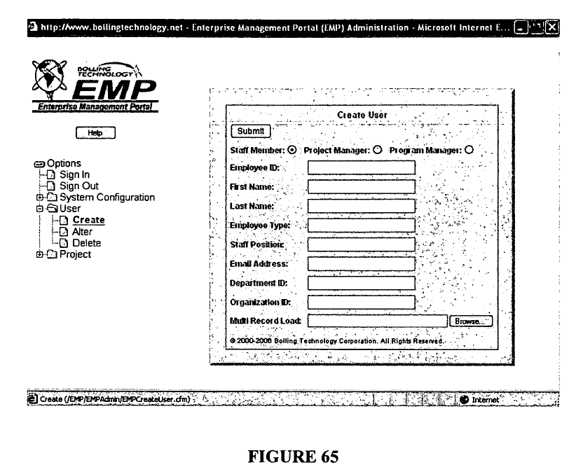

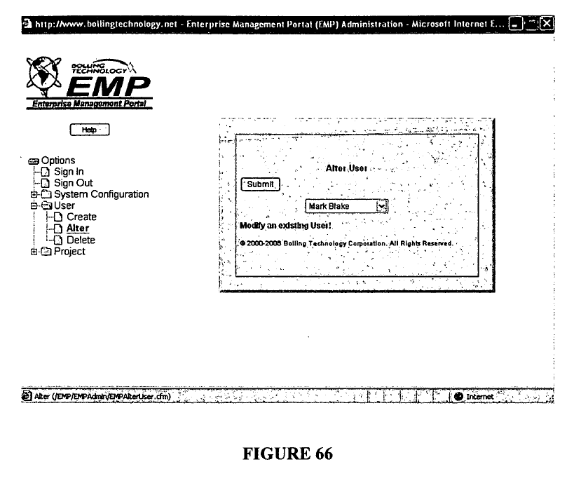

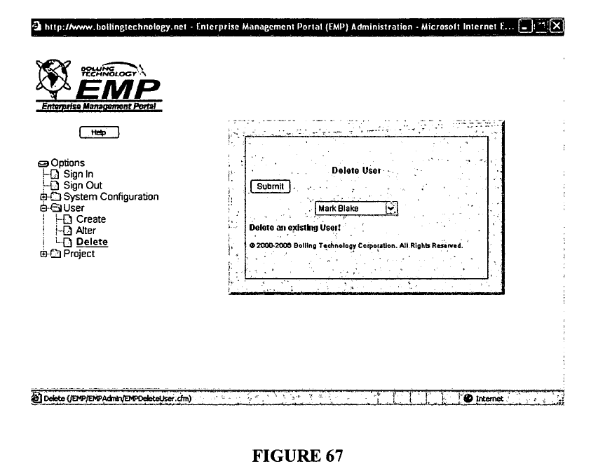

An administrative type of user may additionally manipulate data and parameters related to users of the system. As shown in FIGS. 65-67, an administrative user may create (FIG. 65), alter (FIG. 66), and delete (FIG. 67) users. In creating a user, the administrative user may input indicate whether the new user is a staff member, project manager, or a program manager. Additionally, the administrative user may input various data including, but not limited to, the user's employee ID, user's first name, user's last name, staff position, email address, department ID, organization ID, and a multi record load. The administrative user may then utilize a submit option to create the new user.

In the embodiment shown in FIG. 66, an administrative user may alter data relating to a current user by selecting a particular user from a drop down list of existing users, and utilizing a submit option. As shown in FIG. 67, a user may delete an existing user by utilizing a similar scheme.

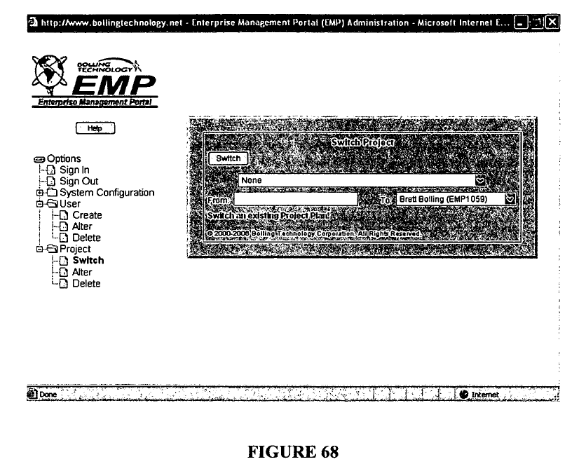

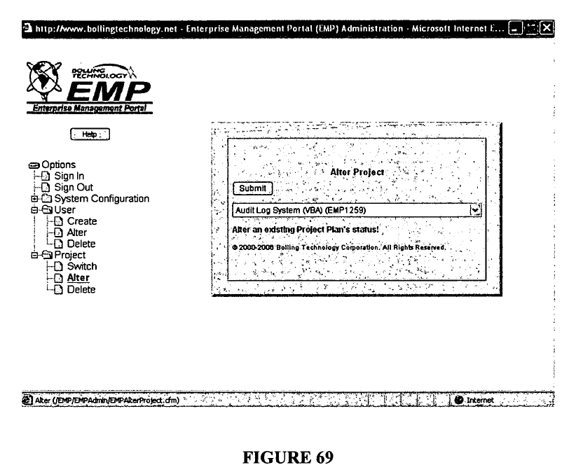

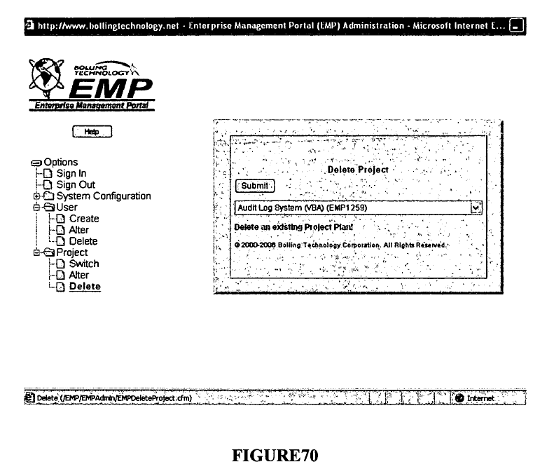

An administrative type of user may additionally manipulate data and parameters related to specific projects. With reference to FIGS. 68-70, an administrative user may switch (FIG. 68), alter (FIG. 69), and delete (FIG. 70) projects. In switching a project, the administrative user may select a current project by utilizing a drop down list of existing projects, and then indicating the current staff member, project manager, program manger, or otherwise, and finally indicating to whom the project is switched, whether it is a different staff member, project manager, program manger, or otherwise.

In the embodiment shown in FIG. 69, an administrative user may alter an existing project by selecting a particular project from a drop down list of existing projects, and utilizing a submit option. A project may be altered by adjusting certain data and parameters related thereto including, for example, approval date, approval status, set baseline, and set base. As show in FIG. 70, a user may delete an existing project by utilizing a similar drop down list and submit option.

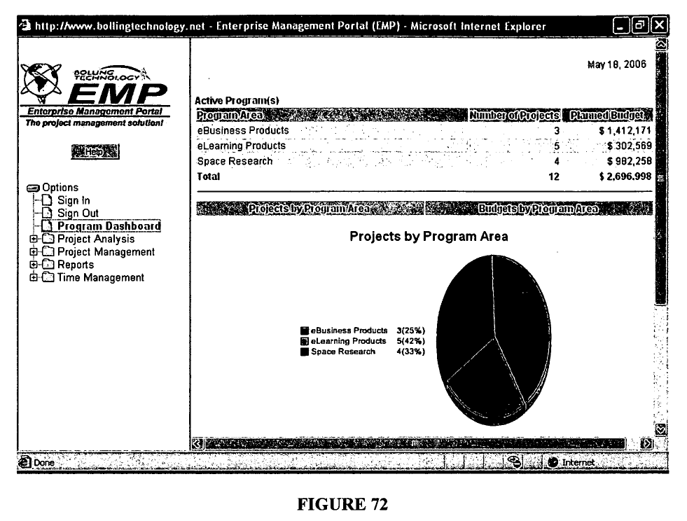

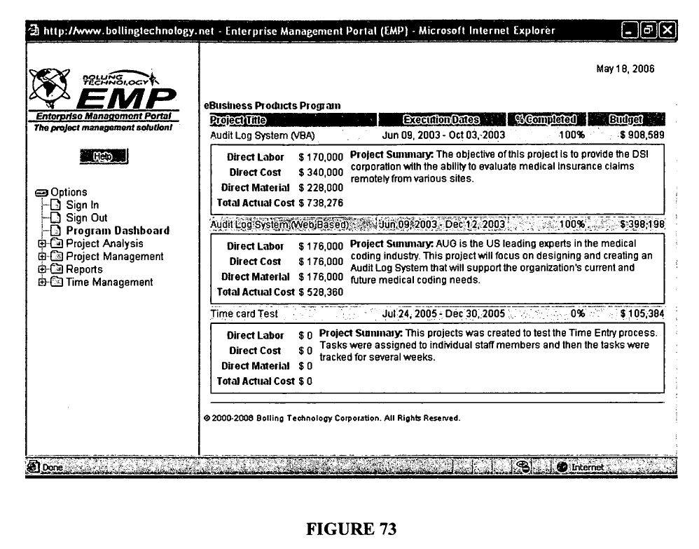

As shown in FIG. 72, the web based management information system of the present invention may further comprise a program dashboard feature. Generally, the program dashboard feature comprises a portfolio of all program areas that a manager is responsible for and the manager can drill down from a summary view of all programs down to summary and detailed views of any aspect that is associated with projects as shown in FIG. 73, but not limited to, program summary, project summary, project completion percentage, direct labor, direct material and direct cost. In certain embodiments, the program dashboard feature may comprise a summary view component and a detailed view component. The summary view component and detailed view component of the program dashboard may provide a manager with a variety of information including, for example, a project status, a task status, a progress report, and a project timeline report.

A person of ordinary skill in the art would recognize that the present invention utilizes certain background processes to facilitate communication between staff members, project managers, and other employees. In certain embodiments, the present invention may utilize one or more notification modules in the context of, for example, cost proposals/approvals and time management components. In a specific embodiment, a cost approval notification may be delivered electronically to a manager for his/her approval. After the manager has approved or disapproved, for example, a response notification may be sent to the project manager.

In another embodiment, in utilizing the time management component, a staff member may identify tasks with which the staff member is having difficulty. The background process may operate to allow the staff member to flag the specific task and a red flag may then appear adjacent to the task in the “Direct Labor” view.

In a further embodiment, one or more notification modules may be used to facilitate communication between staff members and the manager responsible for approving time entries.

Furthermore, the present invention may utilize one or more retrieval and integration modules in the context of managing expenditure data. A retrieval and integration module for managing expenditure data may be executed on enterprise level repositories (e.g., databases or other data storage locations), electronically enabled data subscription feeds (i.e., for receiving data automatically over the Internet via said subscription), or other web data exchange processes like those utilizing the Extensible Markup Language (e.g., XML).

The present invention may also utilize one or more retrieval and integration modules in the context of managing personal and project cost data. A retrieval and integration module for personal and project cost data may be invoked during off-peak business hours by, for example, a pre-configured script. The use of a pre-configured script set to execute during off-peak business hours may allow for increased efficiency in the use of computer resources. Once invoked, a retrieval and integration module for personal and project cost data may be executed on enterprise level repositories (e.g., databases or other data storage locations), electronically enabled data subscription feeds (i.e., for receiving data automatically over the Internet via said subscription), or other web data exchange processes like those utilizing the Extensible Markup Language (e.g., XML).

Without further elaboration, it is believed that one skilled in the art, using the preceding description, can utilize the present invention to the fullest extent. Indeed, one skilled in the art can utilize methods well known in the art to implement the present invention described herein. One example of an implementation of the present invention can be found by accessing United States Copyright Registration Number: TXu1-248-741, which is entirely incorporated herein by reference.

What is claimed is:

1. A web based management information system comprising:
(a) a project analysis feature;
(b) a project management feature;
(c) a report generating feature;
(d) a time management feature; and
(e) a program dashboard feature.

2. The web based management information system of claim 1, wherein said project analysis feature comprises:
(a) a confidence level component;
(b) a matrix analysis component;
(c) a breakeven analysis component; and
(d) a payback analysis component.

3. The web based management information system of claim 2, wherein said confidence level component comprises:
(a) a project type component; and
(b) a comparison component.

4. The web based management information system of claim 3, wherein said project type component comprises:
(a) a type; and
(b) a cost.

5. The web based management information system of claim 3, wherein said comparison component comprises:
(a) a number of units to be entered;
(b) a mean value displayed;
(c) an absolute variance calculated;
(d) a standard deviation calculated;
(e) a probability score;
(f) a confidence interval; and
(g) a confidence level score.

6. The web based management information system of claim 2, wherein said matrix analysis component comprises:
(a) a submit option;
(b) a create analysis option;
(c) a review analysis option; and
(d) a delete analysis option.

7. The web based management information system of claim 6, wherein said create analysis option comprises:
(a) an evaluation criteria field;
(b) an analysis title field;
(c) proposed solutions fields;
(d) a create option;
(e) a save option;
(f) evaluation criteria; and
(g) an evaluation score.

8. The web based management information system of claim 7 further comprising a new matrix for analyzing any of the following:
(a) management benefits criteria;
(b) project analysis criteria;
(c) project management criteria;
(d) reports criteria;
(e) system administration criteria; and
(f) time management criteria.

9. The web based management information system of claim 6, wherein said review analysis option comprises:
(a) a submit option;
(b) a review field;
(c) an update option;
(d) evaluation criteria; and
(e) an evaluation score.

10. The web based management information system of claim 6, wherein said delete analysis option comprises:
(a) a submit option; and
(b) a delete field.

11. The web based management information system of claim 2, wherein said breakeven analysis component comprises:
(a) a submit option;
(b) a create analysis option;
(c) a review analysis option; and
(d) a delete analysis option.

12. The web based management information system of claim 11, wherein said create analysis option comprises:
(a) a create option;
(b) a title field;
(c) a years field;
(d) a months field;
(e) a percentage or whole dollars option;
(f) a current system field;
(g) a current cost field;
(h) a current yearly growth field;
(i) a current monthly growth field;
(j) a proposal system field;
(k) a proposal cost field;
(l) a proposal yearly growth field;
(m) a proposal monthly growth field; and
(n) a save option.

13. The web based management information system of claim 11, wherein said review analysis option comprises:
(a) a submit option;
(b) a review option;
(c) an update option;
(d) a selection field;
(e) a detailed breakeven analysis; and
(f) a breakeven score.

14. The web based management information system of claim 11, wherein said delete analysis option comprises:
(a) a submit option; and
(b) a delete field.

15. The web based management information system of claim 2, wherein said payback analysis component comprises:
(a) a submit option;
(b) a create analysis option;
(c) a review analysis option; and
(d) a delete analysis option.

16. The web based management information system of claim 15, wherein said create analysis option comprises:
(a) a create option;
(b) a title field;
(c) a years field;
(d) a months field;
(e) a percentage or whole dollars field;
(f) a current system field;
(g) a current cost field;
(h) a current yearly growth field;
(i) a current monthly growth field;
(j) a proposal system field;
(k) a proposal cost field;
(l) a proposal yearly growth field
(m) a proposal monthly growth field; and
(n) a save option.

17. The web based management information system of claim 15, wherein said review analysis option comprises:
(a) a submit option;
(b) a review option;
(c) an update option;
(d) a selection field;
(e) a detailed payback analysis; and
(f) a payback time.

18. The web based management information system of claim 15, wherein said delete analysis option comprises:
(a) a submit option; and
(b) a delete field.

19. The web based management information system of claim 1, wherein said project management feature comprises:
(a) a project definition component;
(b) a cost determination component;
(c) a staffing component;
(d) a close component;
(e) an archive component;
(f) a delete component;
(g) a project progress component; and
(h) a project template component.

20. The web based management information system of claim 19, wherein said project definition component comprises:
(a) a load project component;
(b) a define project component;
(c) a task planner component;
(d) a direct labor component;
(e) a direct material component;
(f) a direct cost component; and
(g) a submit component.

21. The web based management information system of claim 20, wherein said load project component comprises:
(a) a submit option;
(b) a start date; and
(c) a selection field.

22. The web based management information system of claim 20, wherein said define project component comprises:
(a) a save option;
(b) a project title;
(c) a charge number;
(d) a start date;
(e) an end date;
(f) a program area;
(g) a program ID;
(h) a project category
(i) a set baseline option;
(j) an approval field;
(k) a cost engine field;
(l) a schedule type field; and
(m) a units field.

23. The web based management information system of claim 20, wherein said task planner component comprises:
(a) a save option;
(b) an add option;
(c) a delete option;
(d) a task definition;
(e) a start date;
(f) an end date; and
(g) a length of time.

24. The web based management information system of claim 20, wherein said direct labor component comprises:
(a) a save option;
(b) a milestone field;
(c) a project task;
(d) a start indicator;
(e) an end indicator;
(f) a slack field;
(g) a position field;
(h) a task total;
(i) a staff field;
(j) check availability option;
(k) a start date; and
(l) an end date.

25. The web based management information system of claim 20, wherein said direct material component comprises:
(a) a save option;
(b) an item;
(c) a cost; and
(d) a remark.

26. The web based management information system of claim 20, wherein said direct cost component comprises:
(a) a save option;
(b) an item;
(c) a cost; and
(d) a remark.

27. The web based management information system of claim 19, wherein said cost determination component comprises:
(a) an active cost engine component; and
(b) a cost proposal component.

28. The web based management information system of claim 19, wherein said staffing component comprises:
(a) a notification component.

29. The web based management information system of claim 19, wherein said archive component comprises:
(a) a project list;
(b) an archive option.

30. The web based management information system of claim 19, wherein said delete component comprises:
(a) a submit option; and
(b) a selection field.

31. The web based management information system of claim 19, wherein said project progress component comprises:
(a) a submit option;
(b) a selection field; and
(c) a progress report.

32. The web based management information system of claim 19, wherein said project template component comprises:
(a) a submit option;
(b) a selection field; and
(c) a template field.

33. The web based management information system of claim 1, wherein said report generating feature comprises:
(a) an actual detail component;
(b) an actual summary component;
(c) a plan summary component;
(d) an analysis component for comparing a plan summary against an actual summary;
(e) an analysis component for comparing a plan summary against a baseline summary; and
(f) an analysis component for comparing a plan summary, a baseline summary, and an actual summary.

34. The web based management information system of claim 33, wherein said actual detail component comprises:
(a) a retrieval component; and
(b) an actual detail report.

35. The web based management information system of claim 34, wherein said retrieval component comprises:
(a) categories;
(b) a start date;
(c) an end date; and
(d) a project field.

36. The web based management information system of claim 33, wherein said actual summary component comprises:
(a) a retrieval component; and
(b) an actual graphical and non-graphical summary report.

37. The web based management information system of claim 36, wherein said retrieval component comprises:
(a) categories;
(b) a start date;
(c) an end date;
(d) a project field;
(e) a text option;
(f) a graph option;
(g) a graph display type option; and
(h) chart properties.

38. The web based management information system of claim 33, wherein said plan summary component comprises:
(a) a retrieval component; and
(b) an actual graphical and non-graphical summary report.

39. The web based management information system of claim 38, wherein said retrieval component comprises:
(a) a project field;
(b) a start date;
(c) an end date;
(d) a text option;
(e) a graph option;
(f) a graph display type option; and
(g) chart properties.

40. The web based management information system of claim 33, wherein said analysis component for comparing plan summary against actual summary comprises:
(a) a retrieval component; and
(b) an actual graphical and non-graphical summary report.

41. The web based management information system of claim 40, wherein said retrieval component comprises:
(a) a project field;
(b) a text option;
(c) a graph option;
(d) a start date;
(e) an end date;
(f) a graph display type option; and
(g) chart properties.

42. The web based management information system of claim 33, wherein said analysis component for comparing plan summary against baseline summary comprises:
(a) a retrieval component; and
(b) an actual graphical and non-graphical summary report.

43. The web based management information system of claim 42, wherein said retrieval component comprises:
(a) a project field;
(b) a text option;
(c) a graph option;
(d) a start date;
(e) an end date;
(f) a graph display type option; and
(g) chart properties.

44. The web based management information system of claim 33, wherein said analysis component for comparing plan summary, baseline summary, and actual summary comprises:
(a) a retrieval component; and
(b) an actual graphical and non-graphical summary report.

45. The web based management information system of claim 44, wherein said retrieval component comprises:
(a) a project field;
(b) a text option;
(c) a graph option;
(d) a start date;
(e) an end date;
(f) a graph display type option; and
(g) chart properties.

46. The web based management information system of claim 1, wherein said time management feature comprises:
(a) a time entry component;
(b) a correct time entry component;
(c) a progress report component;
(d) an approve time component; and
(e) a create time component.

47. The web based management information system of claim 46, wherein said time entry component comprises:
(a) a save option;
(b) a time entry header;
(c) an alert;
(d) a task;
(e) a balance;
(f) a start date;
(g) an end date;
(h) days of week fields;
(i) a total time field;
(j) a progress report field; and
(k) a signature field.

48. The web based management information system of claim 46, wherein said correct time entry component comprises:
(a) time entry choices;
(b) a save option;
(c) a time entry header;
(d) a task;
(e) a balance;
(f) a start date;
(g) an end date;
(h) days of week fields;
(i) a notification field; and
(j) a signature field.

49. The web based management information system of claim 46, wherein said progress report component comprises:
(a) an itemized details of progress.

50. The web based management information system of claim 46, wherein said approve time component comprises:
(a) time entry choices;
(b) a submit option;
(c) a staff field;
(d) a save option;
(e) a time entry header;
(f) a task;
(g) a balance;
(h) a start date;
(i) an end date;
(j) days of week fields;
(k) a comments field; and
(l) a signature field.

51. The web based management information system of claim 46, wherein said create time component comprises:
(a) a submit option; and
(b) a week field.

52. The web based management information system of claim 1, wherein said program dashboard feature comprises:
(a) a summary view component; and
(b) a detailed view component;

53. The web based management information system of claim 52, wherein said summary view component and said detailed view component each comprise:
(a) a project status;
(b) a task status;
(c) a progress report; and
(d) a project timeline report.
